(19) United States
(12) Patent Application Publication
(10) Pub. No.: US 2015/0028272 A1
(43) Pub. Date: Jan. 29, 2015

(54) PHOTOSENSITIVE RESIN COMPOSITION, COLOR FILTER AND LIQUID CRYSTAL DISPLAY DEVICE USING THE SAME

(71) Applicant: CHI MEI CORPORATION, Tainan City (TW)

(72) Inventors: Ching-Yuan TSENG, TAOYUAN COUNTY (TW); Hao-Wei LIAO, KAOHSIUNG CITY (TW)

(21) Appl. No.: 14/326,518

(22) Filed: Jul. 9, 2014

(30) Foreign Application Priority Data
Jul. 23, 2013 (TW) 102126309

(51) Int. Cl. G02B 1/04; G02F 1/1335; G02B 5/23

(52) U.S. Cl. CPC G02B 1/04; G02B 5/23; G02F 1/133512
USPC 252/586

(57) ABSTRACT

The present invention relates to a photosensitive resin composition for a black matrix, a color filter including the black matrix and a liquid crystal display device using the same. The aforementioned photosensitive resin composition includes a polysiloxane (A), a compound having a vinyl unsaturated group (B), a photo initiator (C), a solvent (D) and a black pigment (E). The compound having the vinyl unsaturated group (B) includes a compound having an acidic group and at least three vinyl unsaturated groups (B-1).

### RELATED APPLICATIONS

This application claims priority to Taiwan Application Serial Number 102126309, filed Jul. 23, 2013, which is herein incorporated by reference.

### BACKGROUND

1. Field of Invention

The present invention relates to a photosensitive resin composition for a black matrix, a color filter and a liquid crystal display devices formed by using the black matrix. More particularly, the photosensitive resin composition for the black matrix, the color filter and the liquid crystal display devices have good reliability under high temperature and high humidity conditions.

2. Description of Related Art

In order to improve the contrast ratio and display quality of the current liquid crystal display device, a black matrix is usually disposed between the gaps of the stripe and dot in the color filter, and the black matrix can prevent reduction of the contrast ratio, color purity and other flaws due to light leakage among the pixels. However, the materials used for the black matrix in the conventional composition are mainly vapor deposited films containing chromium, chromium oxide, or the like. However, when the aforementioned vapor deposited film is used as the material for the black matrix, there are defects of complicated process and costly material. Therefore, for solving this problem, it has been proposed to form the black matrix by a photosensitive resin composition via photo-lithographic technology.

In addition, there is a requirement for the light-shielding property of the black matrix in the industry. One solution for meeting the aforementioned requirement is to increase the amount of black pigments, thereby improving the light-shielding property of the black matrix. For example, Japanese Patent Publication No. 2006-259716 discloses a photosensitive resin composition for the black matrix, this photosensitive resin composition contains a high amount of black pigments, an alkali-soluble resin, a photopolymerization initiator, a reactive monomer having a bifunctional group and an organic solvent. The above-mentioned reactive monomer having a bifunctional group can improve the reaction between the compounds, so as to form highly fine patterns. Therefore, in the photosensitive resin composition, when the light-shielding property is improved by increasing the amount of the black pigment, the sensitivity of the photosensitive resin composition is maintained at the same time.

Furthermore, Japanese Patent Publication No. 2008-268854 discloses a photosensitive resin composition for a black matrix. The photosensitive resin composition includes an alkali soluble resin having a carboxyl group and a polymerizable unsaturated group, a photopolymerizable monomer having a vinyl unsaturated group, a photopolymerization initiator and a high amount of black pigments. In the photosensitive resin composition, the specific alkali-soluble resin can improve the resolution of the photosensitive resin composition with high amount of black pigments.

Although the photosensitive resin composition that contains high amount of black pigments can satisfy the requirement of the industry, the above-mentioned photosensitive resin composition has a defect of poor reliability in high temperature and high humidity environments after development.

In view of the aforesaid, there is still a need to develop a photosensitive resin composition for the black matrix with good reliability under high temperature and high humidity conditions.

### SUMMARY

Accordingly, one aspect of the present invention is to provide a photosensitive resin composition, and this photosensitive resin composition has good reliability at high temperature and high humidity environments.

Another aspect of the present invention is to provide a black matrix, which is produced by using the above-mentioned photosensitive resin composition.

Another aspect of the present invention is to provide a color filter, which contains the above-mentioned black matrix.

A further aspect of the present invention is to provide a liquid crystal display device, which contains the aforementioned color filter.

According to the above-mentioned aspects of the present invention, a photosensitive resin composition is proposed, this photosensitive resin composition contains polysiloxane (A), a compound having a vinyl unsaturated group (B), a photo initiator (C), a solvent (D) and a black pigment (E), details will be described below.

### Photosensitive Resin Composition Polysiloxane (A)

The polysiloxane (A) of the present invention may include a polysiloxane having an acid anhydride group or epoxy group (A-1) where the polysiloxane (A-1) is obtained by subjecting a reactant to a polymerization reaction (that is hydrolysis and partial condensation), and the reactant includes silane monomer, siloxane prepolymer or combination thereof.

The silane monomer includes least one silane monomer having a structure of formula (I):

Si(R₁)ₐ(OR₂)₄₋ₐ (I)

In Formula (I), a represents an integer of 1 to 3. When a represents 2 or 3, a plurality of R₁ can be independently the same or different.

In the above-mentioned R₁, at least one of the R₁ represents a C₁-C₁₀ alkyl group substituted by an acid anhydride group, a C₁-C₁₀ alkyl group substituted by an epoxy group or an alkoxy group substituted by an epoxy group. The remaining R₁ represents a hydrogen atom, a C₁-C₁₀ alkyl group, a C₂-C₁₀ alkenyl group or a C₆-C₁₅ aryl group.

The above-mentioned R₂ represents a hydrogen atom, a C₁-C₆ alkyl group, a C₁-C₆ acyl group or a C₆-C₁₅ aryl group. When the (4-a) represents 2 or 3, the above-mentioned R₂ can be independently the same or different.

Specific examples of the C₁-C₁₀ alkyl group substituted by an acid anhydride group are ethyl succinic anhydride, propyl succinic anhydride or propyl glutaric anhydride, or the like.

Specific examples of the C₁-C₁₀ alkyl group substituted by an epoxy group are oxetanylpentyl, 2-(3,4-epoxycyclohexyl)ethyl, or the like.

Specific examples of the alkoxy group substituted by an epoxy group are glycidoxypropyl, 2-oxetanylbutoxy, or the like.

In R₂, the above-mentioned alkyl group may include, but not limited to, methyl group, ethyl group, n-propyl group, isopropyl group, n-butyl group, or the like. The acyl group may include, but not limited to, acetyl group. The aryl group may include, but not limited to, benzyl group.

The silane monomer having a structure of Formula (may include, but not limited to, 3-glycidoxypropyltrimethoxysilane (TMS-GAA), 3-glycidoxypropyltriethoxysilane, 2-(3,4-epoxycyclohexyl)ethyltrimethoxysilane, 2-oxetanylbutoxypropyltriphenoxysilane, 3-(triphenoxysilyl)propyl succinic anhydride, 3-(trimethoxysilyl)propyl glutaric anhydride (TMSG), 3-(triethoxysilyl)propyl glutaric anhydride, 3-(triphenoxysilyl)propyl glutaric anhydride, diisopropoxy-di(2-oxetanylbutoxypropyl)silane (DIDOS), di(3-oxetanylpentyl)dimethoxysilane, (di-n-butoxysilyl)di(propylsuccinic anhydride), (dimethoxysilyl)di(ethylsuccinic anhydride), 3-glycidoxypropyldimethylmethoxysilane, 3-glycidoxypropyldimethylethoxysilane, di(2-oxetanylbutoxypentyl)-2-oxetanylpentylethoxysilane, tri(2-oxetanylpentyl)methoxysilane, (phenoxysilyl)tri(propyl succinic anhydride), (methylmethoxysilyl)di(ethyl succinic anhydride); commercially available 2-oxetanylbutoxypropyltrimethoxysilane (the trade name is TMSOX-D), 2-oxetanybutoxypropyltriethoxysilane (the trade name is TESOX-D), 3-ethyl-3-{[3-(trimethoxysilyl)propoxy]methyl}oxetane (the trade name is TMSOX) manufactured by Toagosei Co. Ltd.; commercially available 3-trimethoxysilylpropyl succinic anhydride (the trade name is X-12-967) manufactured by Shin-Etsu Chemical Co., Ltd.; and commercially available 3-(triethoxysilyl)propyl succinic anhydride (the trade name is GF-20) manufactured by Wacker Chemie AG, or the like. The above-mentioned silane monomer having a structure of Formula (I) can be used alone or in combinations of two or more.

Preferably, the silane monomer can include the silane monomer having a structure of Formula (I-1):

Si(R₃)_{b}(OR₄)_{4-b} (I-1)

In Formula (I-1), R₃ can represent a hydrogen atom, a C₁-C₁₀ alkyl group, a C₂-C₁₀ alkenyl group or a C₆-C₁₅ aryl group; R₄ represents a hydrogen atom, a C₁-C₆ alkyl group, a C₁-C₆ acyl group or a C₆-C₁₅ aryl group. The b represents an integer of 1 to 3. When b represents 2 or 3, a plurality of R₃ can be independently the same or different. When (4-b) represents 2, 3 or 4, the above-mentioned R₄ can be independently the same or different.

In R₃, the alkyl group may include, but not limited to, methyl group, ethyl group, n-propyl group, isopropyl group, n-butyl group, tert-butyl group, n-hexyl group, n-decyl group, trifluoromethyl group, 3,3,3-trifluoropropyl group, 3-aminopropyl group, 3-mercaptopropyl group, 3-isocyanatopropyl group, or the like. The alkenyl group may include, but not limited to, vinyl group, 3-acryloxypropyl group, 3-methacryloxypropyl group, or the like. The aryl group may include, but not limited to, phenyl group, tolyl group, p-hydroxyphenyl group, 1-(p-hydroxyphenyl)ethyl group, 2-(p-hydroxyphenyl)ethyl group, 4-hydroxy-5-(p-hydroxyphenylcarbonyloxy)pentyl group, naphthyl group, or the like.

In R₄, the alkyl group may include, but not limited to, methyl group, ethyl group, n-propyl group, isopropyl group, n-butyl group, or the like. The acyl group may include, but not limited to, acetyl group. The aryl group may include, but not limited to, phenyl group.

The silane monomer having a structure of Formula (I-1) may include, but not limited to, tetramethoxysilane, tetraethoxysilane, tetraacetoxysilane, tetraphenoxysilane, methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, vinyltrimethoxysilane, vinyltriethoxysilane, phenyltrimethoxysilane, phenyltriethoxysilane, p-hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, trifluoromethyltrimethoxysilane, trifluoromethyltriethoxysilane, 3,3,3-trifluoropropyltrimethoxysilane, 3-aminopropyltrimethoxysilane, 3-aminopropyltriethoxysilane, dimethyldimethoxysilane, dimethyldiethoxysilane, dimethyldiacetyloxysilane, di-n-butyldimethoxysilane, diphenyldimethoxysilane, trimethylmethoxysilane, tri-n-butylethoxysilane, 3-mercaptopropyltrimethoxysilane, 3-acryloxypropyltrimethoxysilane, 3-methylacryloxypropyltrimethoxysilane, 3-methylacryloxypropyltriethoxysilane, or the like. The aforementioned silane monomer having a structure of Formula (I-1) can be used alone or in combinations of two or more.

Preferably, the above-mentioned siloxane prepolymer may include a polysiloxane having a structure of Formula (I-2):

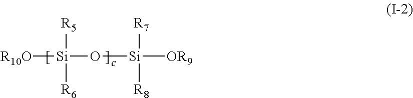

In Formula (I-2), R₅, R₆, R₇, and R₈ can be the same or different, and R₅, R₆, R₇ and R₈ can represent a hydrogen atom, a C₁-C₁₀ alkyl group, a C₁-C₆ alkenyl group or a C₆-C₁₂ aryl group. Any of the above-mentioned alkyl group, alkenyl group or aryl group can selectively include a substituent. The c can represent an integer of 1 to 1000, preferably an integer of 3 to 300, and more preferably an integer of 5 to 200. Each R₅ can be the same or different, and each R₆ can be the same or different.

The above-mentioned alkyl group may include, but not limited to, methyl group, ethyl group, n-propyl group, or the like. The alkenyl group may include, but not limited to, vinyl group, acryloxypropyl group, methylacryloxypropyl group, or the like. The aryl group may include, but not limited to, phenyl group, tolyl group, and naphthyl group.

R₉ and R₁₀ can independently represent a hydrogen atom, a C₁-C₆ alkyl group, a C₁-C₆ acyl group or a C₆-C₁₅ aryl group. Any of the above-mentioned alkyl group, acyl group or aryl group can selectively include a substituent. The alkyl group may include, but not limited to, methyl group, ethyl group, n-propyl group, isopropyl group, and n-butyl group. The acyl group may include, but not limited to, acetyl group. The aryl group may include, but not limited to, phenyl group.

The polysiloxane having a structure of Formula (I-2) may include, but not limited to, 1,1,3,3-tetramethyl-1,3-dimethoxydisiloxane, 1,1,3,3-tetramethyl-1,3-diethoxydisiloxane, 1,1,3,3-tetraethyl-1,3-diethoxydisiloxane or commercially available silanol terminal polysiloxanes manufactured by Gelest Inc., for example, DM-S12 (molecular weight: 400-700), DMS-S15 (molecular weight: 1,500-2,000), DMS-S21 (molecular weight: 4,200), DMS-S27 (molecular weight: 18,000), DMS-S31 (molecular weight: 26,000), DMS-S32 (molecular weight: 36,000), DMS-S33 (molecular weight: 43,500), DMS-S35 (molecular weight: 49,000), DMS-S38 (molecular weight: 58,000), DMS-S42 (molecular weight: 77,000), PDS-9931 (molecular weight: 1,000-1,400), or the like. The aforementioned polysiloxane having a structure of Formula (I-2) can be used alone or in combinations of two or more.

Preferably, the polysiloxane having an acid anhydride group or epoxy group (A-1) is obtained by subjecting the aforementioned silane monomer and/or siloxane prepolymer to a polymerization reaction. The aforementioned reactant can selectively include silicon dioxide particles. There is no specific limitation to the mean particle size of the silicon dioxide particles, and the mean particle size is from 2 nm to 250 nm, preferably is from 5 nm to 200 nm and more preferably is from 10 nm to 100 nm.

The silicon dioxide particles may include, but not limited to, commercially available products manufactured by JGC Catalysts and Chemicals Ltd., and the trade names are OSCAR 1132 (particle size: 12 nm, dispersant: methanol), OSCAR 1332 (particle size: 12 nm, dispersant: n-propanol), OSCAR 105 (particle size 60 nm, dispersant: γ-butyrolactone), OSCAR 106 (particle size: 120 nm, dispersant: diacetone alcohol), or the like; commercially available products manufactured by Fuso Chemical Co., Ltd., and the trade names are Quartron PL-1-IPA (particle size: 13 nm, dispersant: isopropanone), Quartron PL-1-TOL (particle size: 13 nm, dispersant: toluene), Quartron PL-2L-PGME (particle size: 18 nm, dispersant: propylene glycol monomethyl ether), Quartron PL-2L-MEK (particle size: 18 nm, dispersant: methyl ethyl ketone), or the like; and commercially available products manufactured by Nissan Chemical Co. Ltd., and the trade names are IPA-ST (particle size: 12 nm, dispersant: isopropanol), EG-ST (particle size: 12 nm, dispersant: ethylene glycol), IPA-ST-L (particle size: 45 nm, dispersant: isopropanol), IPA-ST-ZL (particle size: 100 nm, dispersant: isopropanol), or the like. The aforementioned examples of the silicon dioxide particles can be used alone or in combinations of two or more.

The above-mentioned partial condensation can be performed in a manner well known in the art. For example, a solvent, water, and optionally a catalyst are added to the silane monomer, followed by stirring at 50° C. to 150° C. for 0.5 to 120 hours. During stirring, the by-products (such as alcohols and water) can be removed by distillation.

There is no specific limitation to the above-mentioned solvent, which can be the same or different from the solvent (D) in the photosensitive resin composition. Based on the silane monomer as 100 g, the amount of the solvent is 15 g to 1200 g, preferably is 20 g to 1100 g, and more preferably is 30 g to 1000 g.

Based on the hydrolyzable groups in the silane monomer as 1 mole, the amount of water used for the hydrolysis is 0.5 moles to 2 moles.

There is no specific limitation to the above-mentioned catalyst, and preferably an acid catalyst or a base catalyst can be selected. The acid catalyst may include, but not limited to, hydrochloric acid, nitric acid, sulfuric acid, hydrofluoric acid, oxalic acid, phosphoric acid, acetic acid, trifluoroacetic acid, formic acid, polycarboxylic acids or anhydrides thereof, ion exchange resins, or the like. The base catalyst may include, but not limited to, diethylamine, triethylamine, tripropylamine, tributylamine, tripentylamine, trihexylamine, triheptylamine, trioctylamine, diethanolamine, triethanolamine, sodium hydroxide, potassium hydroxide, alkoxysilanes having an amino group, ion exchange resins, or the like.

Based on the silane monomer as 100 g, the amount of the catalyst is 0.005 g to 15 g, preferably is 0.01 g to 12 g, and more preferably is 0.05 g to 10 g.

In view of the stability, it is preferred that the polysiloxane having an acid anhydride group or epoxy group (A-1) produced after condensation contains no by-products (for example, alcohols or water) and catalysts, therefore the polysiloxane having an acid anhydride group or epoxy group (A-1) produced can be optionally purified. There is no specific limitation to the purification method, preferably, polysiloxane having an acid anhydride group or epoxy group (A-1) can be diluted with a hydrophobic solvent, and the organic layer that has been washed with water several times is then concentrated with an evaporator to remove the alcohols and water. Additionally, the catalyst can be removed by using an ion exchange resin.

Based on the polysiloxane (A) as 100 parts by weight, the amount of the above-mentioned polysiloxane having an acid anhydride group or epoxy group (A-1) is 30 parts by weight to 100 parts by weight, preferably is 40 parts by weight to 100 parts by weight, and more preferably is 50 parts by weight to 100 parts by weight. Since the polysiloxane having an acid anhydride group or epoxy group (A-1) has a good affinity to silicon hydroxide (SiOH) functional groups on the surface of the glass, thereby increasing the adhesion effect, and thus enhancing the humidity resistance of the photosensitive resin composition. Therefore, when the photosensitive resin composition includes the polysiloxane having an acid anhydride group or epoxy group (A-1), the photosensitive resin composition can further enhance the reliability of the produced black matrix in high temperature and humidity environments.

### Compound Having a Vinyl Unsaturated Group (B)

The compound having a vinyl unsaturated group (B) of the present invention may include a compound having an acidic group and at least three (or more) vinyl unsaturated group (B-1).

The acidic group in the compound having an acidic group and at least three (or more) vinyl unsaturated group (B-1) can produce an effect with an alkaline developer. Specific examples of the acidic group are carboxyl group, sulfonic acid group, phosphoric acid group, or the like, and preferably the acidic group is a carboxyl group that can produce a good effect with the alkaline developer.

The compound having an acidic group and at least three (or more) vinyl unsaturated group (B-1) can be (1) polyfunctional (meth) acrylate having a carboxyl group synthesized by modification of a polyfunctional (meth) acrylate having a hydroxyl group with a dicarboxylic acid anhydride or dibasic acid, or (2) polyfunctional (meth) acrylate having a sulfonic acid group synthesized by modification of an aromatic polyfunctional (meth) acrylate with concentrated sulfuric acid or oleum.

Preferably, the compound having an acidic group and at least three (or more) vinyl unsaturated group (B-1) has a structure of Formula (IV) or (V):

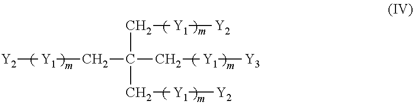

In formula (IV), Y₁ represents —CH₂—, —OCH₂—, —OCH₂CH₂—, —OCH₂CH₂CH₂— or —OCH₂CH₂CH₂CH₂—; Y₂ represents the structures shown in Formula (IV-1) or Formula (IV-2); Y₃ represents the structures shown in Formula (IV-3), Formula (IV-4) or Formula (IV-5), and the benzene ring in the structure of Formula (IV-5) can also be tetrahydrobenzene or hexahydrobenzene; n represents an integer of 1 to 8; and m represents an integer of 0 to 14:

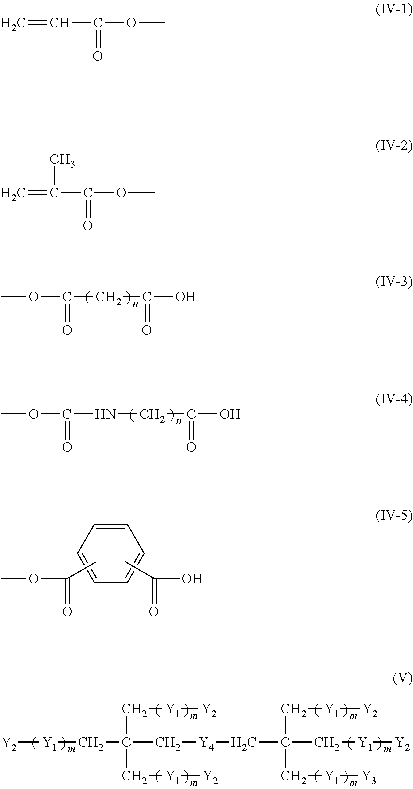

In Formula (V), Y₁, Y₂ and Y₃ is as described above; Y₄ represents —O— or the structure of Formula (V-1); m and n is as described above and p represents an integer of 1 to 8:

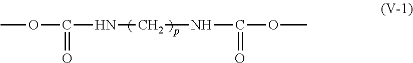

In Formula (IV) or Formula (V), when m is more than 1, a plurality of Y₁ is the same or different; when a plurality of Y₂ is present, each of Y₂ may be independently the same or different.

In specific examples of the compound having an acidic group and at least three (or more) vinyl unsaturated groups (B-1) having a structure of Formula (IV) or Formula (V), specific examples of the compound having three vinyl unsaturated groups (B-1) may be monoester compounds having a carboxyl group formed by reacting monohydroxylic acrylate oligomers or monohydroxylic methacrylate oligomers with diacids. For example, the monohydroxylic acrylate oligomers or monohydroxylic methacrylate oligomersmay be pentaerythritol triacrylate, pentaerythritol trimethacrylate, dipentaerythritol pentaacrylate, dipentaerythritol pentamethacrylate, or the like, and the diacids may be malonic acid, succinic acid, glutaric acid, isophthalic acid, terephthalic acid, phthalic acid or the like. The compound having three vinyl unsaturated groups (B-1) can be commercial products manufactured by Toagosei Co. Ltd., and the trade name is TO-756; products manufactured by Kyoeisha Chemical Co. Ltd., and the trade name is PE3A-MS or PE3A-MP. Specific examples of the compound having five vinyl unsaturated group (B-1) may be commercial products manufactured by Toagosei Co. Ltd., and the trade name is TO-1382 or TO-1385; products manufactured by Kyoeisha Chemical Co. Ltd., and the trade name is DPE6A-MS or DPR6A-MP.

The above-mentioned compound having an acidic group and at least three (or more) vinyl unsaturated group are preferably monoester compounds having a carboxyl group formed by reacting pentaerythritol triacrylate, pentaerythritol trimethacrylate, dipentaerythritol pentaacrylate or dipentaerythritol pentamethacrylate with succinic acid or phthalic acid.

Based on the aforementioned polysiloxane (A) as 100 parts by weight, the amount of the compound having an acidic group and at least three vinyl unsaturated groups (B-1) is 10 parts by weight to 150 parts by weight, preferably is 15 parts by weight to 130 parts by weight, and more preferably is 20 parts by weight to 120 parts by weight. Since the acidic group of the compound (B-1) can react with the functional groups of the polysiloxane, thereby improving the adhesion effect of the photosensitive resin composition on the glass and enhancing the humidity resistance. Therefore, when the compound having a vinyl unsaturated group (B) of the present invention do not include the compound having an acidic group and at least three vinyl unsaturated groups (B-1), the produced black matrix will have poor reliability in high temperature and high humidity environment.

The compound having a vinyl unsaturated group (B) may further include other compounds having a vinyl unsaturated group (B-2).

The other compounds having a vinyl unsaturated group (B-2) can be selected from compounds having one vinyl unsaturated group or compounds having two or more (including two) vinyl unsaturated groups.

The above-mentioned compounds having one vinyl unsaturated group can include, but not limited to, (meth)acrylamide, (meth)acryloylmorpholine, 7-amine-3,7-dimethyloctyl(meth)acrylate, isobutoxymethyl(meth)acrylamide, isobornyloxyethyl(meth)acrylate, isobornyl(meth)acrylate, 2-ethylhexyl(meth)acrylate, ethyldiethylene glycol(meth)acrylate, t-octyl(meth)acrylamide, diacetone(meth)acrylamide, dimethylaminoethyl(meth)acrylate, dodecyl(meth)acrylate, dicyclopentenyloxyethyl(meth)acrylate, dicyclopentadiene(meth)acrylate, N,N-dimethyl(meth)acrylamide, tetrachlorophenyl(meth)acrylate, 2-tetrachlorophenoxyethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate, bornyl(meth)acrylate, or the like. The compounds having one vinyl unsaturated group can be used alone or in combinations of two or more.

The above-mentioned compounds having two or more (including two) vinyl unsaturated groups can include, but not limited to, ethylene glycol di(meth)acrylate, dicyclopentenyl di(meth)acrylate, triethylene glycol di(meth)acrylate, tetraethylene glycol di(meth)acrylate, tris(2-hydroxyethyl)isocyanurate di(meth)acrylate, tris(2-hydroxyethyl)isocyanurate tri(meth)acrylate, caprolactone-modified tris(2-hydroxyethyl)isocyanurate tri(meth)acrylate, trimethylolpropyl tri(meth)acrylate, EO-modified trimethylolpropyl tri(meth)acrylate, PO-modified trimethylolpropyl tri(meth)acrylate, tripropylene glycol di(meth)acrylate, neopentyl glycol di(meth)acrylate, 1,4-butanediol di(meth)acrylate, 1,6-hexanediol di(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, di(trimethylolpropane)tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, EO-modified bisphenol F di(meth)acrylate, novolac polyglycidyl ether(meth)acrylate, or the like. The above-mentioned compounds having two or more (including two) vinyl unsaturated groups can be used alone or in combinations of two or more.

Specific examples of other compounds having two or more (including two) vinyl unsaturated groups (B-2) can include, but not limited to, trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, di(trimethylolpropyl)tetraacrylate, PO-modified glycerol triacrylate, or a combination thereof.

Based on the polysiloxane (A) as 100 parts by weight, the amount of the compound having a vinyl unsaturated group (B) is 20 parts by weight to 200 parts by weight, preferably is 30 parts by weight to 170 parts by weight, and more preferably is 40 parts by weight to 150 parts by weight, thereby allowing the photosensitive resin composition to have good developability

### Photo Initiator (C)

There is no specific limitation to the photo initiator (C). In one embodiment, the photo initiator (C) can include, but not limited to, O-acyloxime compounds, triazine compounds, acetophenone compounds, biimidazole compounds, benzophenone compounds, α-diketone compounds, acyloin compounds, acyloin ether compounds, acylphosphine oxide compounds, quinone compounds, halogen-containing compound, peroxides, or the like. All of which are described in details as follows.

Specific examples of the above-mentioned O-acyloxime compounds include, but not limited to, 1-[4-(phenylthio)phenyl]-heptane-1,2-dione-2-(O-benzoyloxime), 1-[4-(phenylthio)phenyl]-octane-1,2-dione-2-(O-benzoyloxime), 1-[4-(benzoyl)phenyl]-heptane-1,2-dione-2-(O-benzoyloxime), 1-[9-ethyl-6-(2-methylbenzoyl)-9H-carbazol-3-yl]-ethylketo-1-(O-acetyloxime), 1-[9-ethyl-6-(3-methylbenzoyl)-9H-carbazol-3-yl]-ethylketo-1-(O-acetyloxime), 1-[9-ethyl-6-benzoyl-9H-carbazol-3-yl]-ethylketo-1-(O-acetyloxime), ethylketo-1-[9-ethyl-6-(2-methyl-4-tetrahydrofurylbenzoyl)-9H-carbazol-3-yl]-1-(O-acetyloxime), ethylketo-1-[9-ethyl-6-(2-methyl-4-tetrapyranylbenzoyl)-9H-carbazol-3-yl]-1-(O-acetyloxime), ethylketo-1-[9-ethyl-6-(2-methyl-5-tetrafurylbenzoyl)-9H-carbazol-3-yl]-1-(O-acetyloxime), ethylketo-1-[9-ethyl-6-(2-methyl-5-tetrapyranylbenzoyl)-9H-carbazol-3-yl]-1-(O-acetyloxime), ethylketo-1-[9-ethyl-6-(2-methyl-4-tetrafurylmethoxybenzoyl)-9H-carbazol-3-yl]-1-(O-acetyloxime), ethylketo-1-[9-ethyl-6-(2-methyl-4-tetrapyranylmethoxybenzoyl)-9H-carbazol-3-yl]-1-(O-acetyloxime), ethylketo-1-[9-ethyl-6-(2-methyl-5-tetrafurylmethoxybenzoyl)-9H-carbazol-3-yl]-1-(O-acetyloxime), ethylketo-1-[9-ethyl-6-(2-methyl-5-tetra pyranylmethoxybenzoyl)-9H-carbazol-3-yl]-1-(O-acetyloxime), ethylketo-1-{9-ethyl-6-[2-methyl-4-(2,2-dimethyl-1,3-dioxolyl)benzoyl]-9H-carbazol-3-yl}-1-(O-acetyloxime), ethylketo-1-{9-ethyl-6-[2-methyl-4-(2,2-dimethyl-1,3-dioxolyl)methoxy benzoyl]-9H-carbazol-3-yl}-1-(O-acetyloxime), or the like. The above-mentioned O-acyloxime compounds can be used alone or in combinations of two or more.

The above-mentioned O-acyloxime compounds is preferably 1-[4-(phenylthio)phenyl]-octane-1,2-dione-2-(O-benzoyloxime) (such as the product manufactured by Ciba Specialty Chemicals Co. Ltd., and the trade name is OXE 01), 1-[9-ethyl-6-(2-methylbenzoyl)-9H-carbazol-3-yl]-ethylketo-1-(O-acetyloxime) (such as the product manufactured by Ciba Specialty Chemicals Co. Ltd., and the trade name is OXE 02), ethylketo-1-[9-ethyl-6-(2-methyl-4-tetrahydrofurylbenzoyl)-9H-carbazol-3-yl]-1-(O-acetyloxime), ethylketo-1-{9-ethyl-6-[2-methyl-4-(2,2-dimethyl-1,3-dioxolyl)methoxybenzoyl]-9H-carbazol-3-yl}-1-(O-acetyloxime), or the like.

The above-mentioned triazine compounds may include, but not limited to, vinyl-halomethyl-s-triazine compounds, 2-(naphtho-1-yl)-4,6-bis-halomethyl-s-triazine compounds, 4-(p-aminophenyl)-2,6-di-halomethyl-s-triazine compounds, or the like.

Specific examples of the above-mentioned vinyl-halomethyl-s-triazine compounds are 2,4-bis(trichloromethyl)-6-p-methoxystyryl-s-triazine, 2,4-bis(trichloromethyl)-6-(1-p-dimethylaminophenyl-1,3-butadienyl)-s-triazine, 2-trichloromethyl-3-amino-6-p-methoxystyryl-s-triazine, or the like.

Specific examples of the above-mentioned 2-(naphtho-1-yl)-4,6-bis-halomethyl-s-triazine compounds are 2-(naphtho-1-yl)-4,6-bis-trichloromethyl-s-triazine, 2-(4-methoxy-naphtho-1-yl)-4,6-bis-trichloromethyl-s-triazine, 2-(4-ethoxy-naphtho-1-yl)-4,6-bis-trichloromethyl-s-triazine, 2-(4-butoxy-naphtho-1-yl)-4,6-bis-trichloromethyl-s-triazine, 2-[4-(2-methoxyethyl)-naphtho-1-yl]-4,6-bis-trichloromethyl-s-triazine, 2-[4-(2-ethoxyethyl)-naphtho-1-yl]-4,6-bis-trichloromethyl-s-triazine, 2-[4-(2-butoxyethyl-naphtho-1-yl)4,6-bis-trichloromethyl-s-triazine, 2-(2-methoxy-naphtho-1-yl)-4,6-bis-trichloromethyl-s-triazine, 2-(6-methoxy-5-methyl-naphtho-2-yl)-4,6-bis-trichloromethyl-s-triazine, 2-(6-methoxy-naphtho-2-yl)-4,6-bis-trichloromethyl-s-triazine, 2-(5-methoxy-naphtho-1-yl)-4,6-bis-trichloromethyl-s-triazine, 2-(4,7-dimethoxy-naphtho-1-yl)-4,6-bis-trichloromethyl-s-triazine, 2-(6-ethoxy-naphtho-2-yl)-4,6-bis-trichloromethyl-s-triazine, 2-(4,5-dimethoxy-naphtho-1-yl)-4,6-bis-trichloromethyl-s-triazine, or the like.

Specific examples of the above-mentioned 4-(p-aminophenyl)-2,6-di-halomethyl-s-triazine compounds are 4-[p-N, N-di(ethoxycarbonylmethyl)aminophenyl]-2,6-di(trichloromethyl)-s-triazine, 4-[o-methyl-p-N,N-di(ethoxycarbonylmethyl)aminophenyl]-2,6-di(trichloromethyl)-s-triazine, 4-[p-N,N-di(chloroethyl)aminophenyl]-2,6-di(trichloromethyl)-s-triazine, 4-[o-methyl-p-N,N-di(chloroethyl)aminophenyl]-2,6-di(trichloromethyl)-s-triazine 4-[p-N-chloroethylaminophenyl]-2,6-di(trichloromethyl)-s-triazine, 4-[p-N-ethoxycarbonylmethylaminophenyl]-2,6-di(trichloromethyl)-s-triazine, 4-[p-N,N-di(phenyl)aminophenyl]-2,6-di(trichloromethyl)-s-triazine, 4-[p-N-chloroethylcarbonylaminophenyl]-2,6-di(trichloromethyl)-s-triazine, 4-[p-N-(p-methoxyphenyl)carbonylaminophenyl]-2,6-di(trichloromethyl)-s-triazine, 4-[m-N,N-di(ethoxycarbonylmethyl)aminophenyl]-2,6-di(trichloromethyl)-s-triazine, 4-[m-bromo-p-N,N-di(ethoxycarbonylmethyl)aminophenyl]-2,6-di(trichloromethyl)-s-triazine, 4-[m-chloro-p-N,N-di(ethoxycarbonylmethyl)aminophenyl]-2,6-di(trichloromethyl)-s-triazine, 4-[m-fluoro-p-N,N-di(ethoxycarbonylmethyl)aminophenyl]-2,6-di(trichloromethyl)-s-triazine, 4-[o-bromo-p-N,N-di(ethoxycarbonylmethyl)aminophenyl]-2,6-di(trichloromethyl)-s-triazine, 4-[o-chloro-p-N,N-di(ethoxycarbonylmethyl)aminophenyl]-2,6-di(trichloromethyl)-s-triazine, 4-[o-fluoro-p-N,N-di(ethoxycarbonylmethyl)aminophenyl]-2,6-di(trichloromethyl)-s-triazine, 4-[o-bromo-p-N,N-di(chloroethyl)aminophenyl]-2,6-di(trichloromethyl)-s-triazine, 4-[o-chloro-p-N,N-di(chloroethyl)aminophenyl]-2,6-di(trichloromethyl)-s-triazine, 4-[o-fluoro-p-N,N-di(chloroethyl)aminophenyl]-2,6-di(trichloromethyl)-s-triazine, 4-[m-bromo-p-N,N-di(chloroethyl)aminophenyl]-2,6-di(trichloromethyl)-s-triazine, 4-[m-chloro-p-N,N-di(chloroethyl)aminophenyl]-2,6-di(trichloromethyl)-s-triazine, 4-[m-fluoro-p-N, N-di(chloroethyl)aminophenyl]-2,6-di(trichloromethyl)-s-triazine, 4-(m-bromo-p-N-ethoxycarbonyl methylaminophenyl)-2,6-di(trichloromethyl)-s-triazine, 4-(m-chloro-p-N-ethoxycarbonylmethylaminophenyl)-2,6-di(trichloromethyl)-s-triazine, 4-(m-fluoro-p-N-ethoxycarbonylmethylaminophenyl)-2,6-di(trichloromethyl)-s-triazine, 4-(o-bromo-p-N-ethoxycarbonylmethylaminophenyl)-2,6-di(trichloromethyl)-s-triazine, 4-(o-chloro-p-N-ethoxycarbonylmethylaminophenyl)-2,6-di(trichloromethyl)-s-triazine, 4-(o-fluoro-p-N-ethoxycarbonylmethylaminophenyl)-2,6-di(trichloromethyl)-s-triazine, 4-(m-bromo-p-N-chloroethylaminophenyl)-2,6-di(trichloromethyl)-s-triazine, 4-(m-chloro-p-N-chloroethylaminophenyl)-2,6-di(trichloromethyl)-s-triazine, 4-(m-fluoro-p-N-chloroethylaminophenyl)-2,6-di(trichloromethyl)-s-triazine, 4-(o-bromo-p-N-chloroethylaminophenyl)-2,6-di(trichloromethyl)-s-triazine, 4-(o-chloro-p-N-chloroethylaminophenyl)-2,6-di(trichloromethyl)-s-triazine, 4-(o-fluoro-p-N-chloroethylaminophenyl)-2,6-di(trichloromethyl)-s-triazine, 2,4-bis(trichloromethyl)-6-{3-bromo-4-[N,N-di(ethoxycarbonylmethyl)amino]phenyl}-1,3,5-triazine, or the like. The above-mentioned triazine compounds can be used alone or in combinations of two or more.

Preferably, the above-mentioned triazine compounds are 4-[m-bromo-p-N,N-di(ethoxycarbonylmethyl)aminophenyl]-2,6-di(trichloromethyl)-s-triazine or 2,4-bis(trichloromethyl)-6-p-methoxystyryl-s-triazine.

Specific examples of the above-mentioned acetophenone compounds are p-dimethylamino-acetophenone, α,α′-dimethoxyazoxyacetophenone, 2,2′-dimethyl-2-phenylacetophenone, p-methoxyacetophenone, 2-methyl-1-[4-(methylthio)phenyl]-2-morpholino-1-propanone, 2-benzyl-2-N,N-dimethylamino-1-(4-morpholinophenyl)-1-butanone, or the like. The above-mentioned acetophenone compounds can be used alone or in combinations of two or more. Preferably, the above-mentioned acetophenone compounds are 2-methyl-1-[4-(methylthio)phenyl]-2-morpholino-1-propanone or 2-benzyl-2-N,N-dimethylamino-1-(4-morpholinophenyl)-1-butanone.

Specific examples of the above-mentioned biimidazole compounds are 2,2′-bis(o-chlorophenyl)-4,4′,5,5′-tetraphenylbiimidazole, 2,2′-bis(o-fluorophenyl)-4,4′,5,5′-tetraphenylbiimidazole, 2,2′-bis(o-methylphenyl)-4,4′,5,5′-tetraphenylbiimidazole, 2,2′-bis(o-methoxyphenyl)-4,4′,5,5′-tetraphenylbiimidazole, 2,2′-bis(o-ethylphenyl)-4,4′,5,5′-tetraphenylbiimidazole, 2,2′-bis(p-methoxyphenyl)-4,4′,5,5′-tetraphenylbiimidazole, 2,2′-bis(2,2′,4,4′-tetramethoxyphenyl)-4,4′,5,5′-tetraphenylbiimidazole, 2,2′-bis(2-chlorophenyl)-4,4′,5,5′-tetraphenylbiimidazole, 2,2′-bis(2,4-dichlorophenyl)-4,4′,5,5′-tetraphenylbiimidazole, or the like. The above-mentioned blimidazole compounds can be used alone or in combinations of two or more. Preferably, the above-mentioned biimidazole compounds are 2,2′-bis(2,4-dichlorophenyl)-4,4′,5,5′-tetraphenylbiimidazole.

Specific examples of the above-mentioned benzophenone compounds are thioxanthone, 2,4-diethylthioxanthone, thioxanthone-4-sulfone, benzophenone, 4,4′-bis(dimethylamino)benzophenone, 4,4′-bis(diethylamino)benzophenone, or the like. The above-mentioned benzophenone compounds can be used alone or in combinations of two or more. Preferably, the above-mentioned benzophenone compounds are 4,4′-bis(diethylamino)benzophenone.

Specific examples of the above-mentioned α-diketone compounds are benzil, acetyl, or the like. Specific example of the above-mentioned acyloin compounds is benzoin. Specific examples of the above-mentioned acyloin ether compounds are benzoin methylether, benzoin ethylether, benzoin isopropyl ether, or the like. Specific examples of the above-mentioned acylphosphine oxide compounds are 2,4,6-trimethyl-benzoyldiphenylphosphine oxide, bis-(2,6-dimethoxybenzoyl)-2,4,4-trimethylbenzylphosphine oxide, or the like.

Specific examples of the above-mentioned quinone compounds are anthraquinone, 1,4-naphthoquinone, or the like.

Specific examples of the above-mentioned halogen-containing compounds are phenacyl chloride, tribromomethylphenylsulfone, tris(trichloromethyl)-s-triazine, or the like. Specific example of the above-mentioned peroxides is di-tertbutylperoxide, or the like. The above-mentioned α-diketone compounds, acyloin compounds, acyloin ether compounds, acylphosphine oxide compounds, quinone compounds, halogen-containing compounds or peroxides can be used alone or in combinations of two or more.

The amount of the photo initiator (C) can be adjusted according to the requirements, based on the amount of polysiloxane (A) as 100 parts by weight, the amount of the photo initiator (C) is 10 parts by weight to 100 parts by weight, preferably is 12 parts by weight to 90 parts by weight, and more preferably is 15 parts by weight to 80 parts by weight.

### Solvent (D)

The suitable solvent (D) of the present invention can dissolve the aforementioned polysiloxane (A), the compound having a vinyl unsaturated group (B), the photo initiator (C), and the following black pigment (E), and the solvent (D) does not react with any of the above-mentioned component. The solvent (D) preferably has an appropriate volatility.

Specific examples of the above-mentioned solvent (D) are alkylene glycol monoalkyl ether solvents such as ethylene glycol monomethyl ether, ethylene glycol monoethyl ether, diethylene glycol monoethyl ether, diethylene glycol n-propyl ether, diethylene glycol n-butyl ether, triethylene glycol monomethyl ether, triethylene glycol monoethyl ether, propylene glycol monomethyl ether, propylene glycol monoethyl ether, dipropylene glycol monomethyl ether, dipropylene glycol monoethyl ether, dipropylene glycol n-propyl ether, dipropylene glycol n-butyl ether, tripropylene glycol monomethyl ether, tripropylene glycol monoethyl ether and the like; alkylene glycol monoalkyl ether acetate sovents such as ethylene glycol monomethyl ether acetate, ethylene glycol monoethyl ether acetate, propylene glycol monomethyl ether acetate, propylene glycol monoethyl ether acetate and the like; ether solvents such as diethylene glycol dimethyl ether, diethylene glycol methyl ethyl ether, diethylene glycol diethyl ether, tetrahydrofuran and the like; ketone solvents such as methyl ethyl ketone, cyclohexanone, 2-heptanone, 3-heptanone, diacetone alcohol, 4-hydroxy-4-methyl-2-pentanone and the like; alkyl lactate solvents such as methyl lactate, ethyl lactate and the like; ester solvents such as methyl 2-hydroxy-2-methylpropionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxy acetate, ethyl hydroxy acetate, methyl 2-hydroxy-3-methylbutyrate, 3-methyl-3-methoxybutyl acetate, 3-methyl-3-methoxybutyl propionate, ethyl acetate, n-propyl acetate, iso-propyl acetate, n-butyl acetate, iso-butyl acetate, n-amyl acetate, iso-amyl acetate, n-butyl propionate, ethyl butyrate, n-propyl butyrate, iso-propyl butyrate, n-butyl butyrate, methyl pyruvate, ethyl pyruvate, n-propyl pyruvate, methyl acetoacetate, ethyl acetoacetate, ethyl 2-oxobutyrate and the like; aromatic hydrocarbon solvents such as toluene, xylene and the like; and carboxylic acid amide solvents such as N-methyl-2-pyrrolidone, N,N-dimethylformamide, N,N-dimethylacetamide and the like. The above-mentioned solvent (D) can be used alone or in combinations of two or more.

Based on the polysiloxane (A) as 100 parts by weight, the amount of solvent (D) is 1000 parts by weight to 5000 parts by weight, preferably is 1200 parts by weight to 4500 parts by weight, and more preferably is 1500 parts by weight to 4000 parts by weight.

### Black Pigment (E)

Preferably, the black pigment (E) of the present invention has heat-resistant property, photo-resistant property and solvent-resistant property.

Specific examples of the black pigment (E) are black organic pigments such as perylene black, cyanine black, aniline black and the like; organic pigments with black-approach color formed by mixing at least two pigments selected from the group consisting of red, blue, green, purple, yellow, cyanine, magenta and the like pigments; light-shielding materials such as carbon black, chromium oxide, iron oxide, titanium black, graphite and the like. The aforementioned carbon black can include, but not limited to, C.I. pigment black 7 and the like, and the specific examples of the carbon black are commercial product manufactured by Mitsubishi Chemical Co. Ltd., and the trade name is MA100, MA230, MA8, #970, #1000, #2350, or #2650. The above-mentioned black pigment (E) can be used alone or in combinations of two or more.

Based on the polysiloxane (A) as 100 parts by weight, the amount of black pigment (E) is 100 parts by weight to 1000 parts by weight, preferably is 150 parts by weight to 900 parts by weight, and more preferably is 200 parts by weight to 800 parts by weight.

### Resin Having Unsaturated Group (F)

The resin having unsaturated group (F) of the present invention is prepared by polymerization of a mixture. The mixture includes an epoxy compound having at least two epoxy groups (i) and a compound having at least one carboxyl group and at least one vinyl unsaturated group (ii). The above-mentioned mixture can selectively include a carboxylic anhydride compound (iii) and/or a compound having an epoxy group (iv).

Epoxy Compound Having at Least Two Epoxy Groups (i)

The epoxy compound having at least two epoxy groups (i) has the structure shown in Formula (II) or Formula (III):

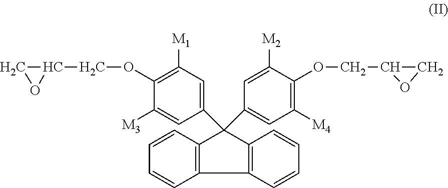

In Formula (II), M₁, M₂, M₃ and M₄ are independently the same or different, and M₁, M₂, M₃ and M₄ independently represent a hydrogen atom, a halogen atom, a C₁-C₅ alkyl group, a C₁-C₅ alkoxy group, a C₆-C₁₂ aryl group or a C₆-C₁₂ aralkyl group.

The epoxy compound having at least two epoxy groups (i) having a structure of Formula (II) can include, but not limited to, a bisphenol fluorine having epoxy groups, which is obtained by reacting bisphenol fluorene with epihalohydrin.

Specific examples of the above-mentioned bisphenol fluorine can include, but not limited to, 9,9-bis(4-hydroxyphenyl)fluorene, 9,9-bis(4-hydroxy-3-methylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3-methoxyphenyl)fluorene, 9,9-bis(4-hydroxy-3,5-dimethylphenyl)fluorene, 9,9-bis(4-hydroxy-3,5-dichlorophenyl)fluorene, 9,9-bis(4-hydroxy-3,5-dibromophenyl)fluorene, or the like.

The above-mentioned epihalohydrin may include, but not limited to, epichlorohydrin and epibromohydrin.

The above-mentioned bisphenol fluorine having at least two epoxy groups may include, but are not limited to, commercially available products manufactured by Nippon Steel Chemical Co. Ltd., and the trade name is ESF-300; the products manufactured by Osaka Gas Co. Ltd., and the trade name is PG-100 or EG-210; and the products manufactured by S.M.S. Technology Co. Ltd., and the trade name is SMS-F9PhPG, SMS-F9CrG or SMS-F914PG.

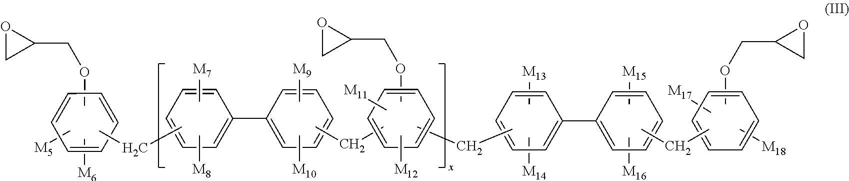

In Formula (III), M₅ to M₁₈ can be independently the same or different. M₅ to M₁₈ may represent a hydrogen atom, a halogen atom, a C₁-C₈ alkyl group, or a C₆-C₁₅ aryl group. The x represents an integer of 0 to 10.

The epoxy compound having at least two epoxy groups (i) shown in Formula (III) above may be obtained by subjecting a compound with the structure shown in Formula (III-1) below and epihalohydrin to a reaction in the presence of alkali metal hydroxide:

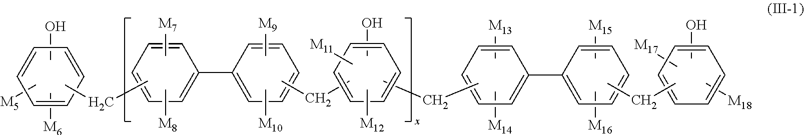

In Formula (III-1), M₅ to M₁₈ and x is the same as above, therefore not mentioning herein.

Furthermore, the above-mentioned epoxy compound having at least two epoxy groups (i) having a structure of Formula (III) is obtained by firstly subjecting to a condensation reaction with a compound having a structure of Formula (III-1) and phenol with an acid catalyst, so as to form a compound having a structure of Formula (III-1). Then, the excess amount of the epihalohydrin is added, and a dehydrohalogenation reaction is performed to obtain the compound having a structure of Formula (III):

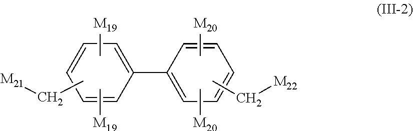

In Formula (III-2), M₁₉ to M₂₀ can be independently the same or different. M₁₉ to M₂₀ may represent a hydrogen atom, a halogen atom, a C₁-C₈ alkyl group, a C₆-C₁₅ aryl group; M₂₁ and M₂₂ can respectively the same or different, and M₂₁ and M₂₂ can be a halogen atom, a C₁-C₆ alkyl group or a C₁-C₆ alkoxy group. Preferably, the above-mentioned halogen atom can be a chlorine or bromine atom, the alkyl group can be a methyl group, ethyl group, or t-butyl group, and the alkoxy group can be a methoxy group or ethoxy group.

Specific examples of the above-mentioned phenols are phenol, cresol, ethylphenol, n-propylphenol, isobutylphenol, t-butylphenol, octylphenol, nonylphenol, xylenol, methylbutylphenol, di-t-butylphenol, vinylphenol, propenylphenol, ethinylphenol, cyclopentylphenol, cyclohexylphenol, cyclohexylcresol and the like. The aforementioned phenols can be used alone or in combinations thereof.

Based on the compound having a structure of Formula (III-2) as 1 mole, the amount of phenols is 0.5 moles to 20 moles, and preferably is 2 moles to 15 moles.

Specific examples of the above-mentioned acid catalyst are hydrochloric acid, sulfuric acid, p-toluenesulfonic acid, oxalic acid, boron trifluoride, aluminium chloride anhydrous, and zinc chloride, and the acid catalyst preferably is p-toluenesulfonic acid, sulfuric acid or hydrochloric acid. The aforementioned acid catalyst can be used alone or in combinations thereof.

Based on the compound having a structure of Formula (III-2) as 100 wt %, the amount of the acid catalyst is 0.1 wt % to 30 wt %.

The above-mentioned condensation reaction can be performed in the absence of organic solvent or in the presence of organic solvent. Furthermore, specific examples of the above-mentioned organic solvent are toluene, xylene, and methyl isobutyl ketone. The aforementioned organic solvent can be used alone or in combinations thereof.

Based on the compound having a structure of Formula (III-2) as 100 wt %, the amount of the organic solvent is 50 wt % to 300 wt %, and preferably is 100 wt % to 250 wt %. In addition, the aforementioned condensation reaction is performed at 40° C. to 180° C. for 1 hour to 8 hours.

After the condensation reaction is completed, neutralization treatment or rinsing treatment can be performed. The neutralization treatment is to adjust the pH value of the reacted solution to 3 to 7, and preferably is to 5 to 7. The above-mentioned rinsing treatment can be performed with a neutralizing agent. The neutralizing agent is a basic compound, and specific examples of the neutralizing agent are alkali metal hydroxides such as sodium hydroxide, potassium hydroxide and the like; alkaline earth metal hydroxides such as calcium hydroxide, magnesium hydroxide and the like; organic amines such as diethylene triamine, triethylene tetramine, aniline, phenylene diamine and the like; ammonia, sodium dihydrogen phosphate and other basic compounds. The above-mentioned rinsing treatment can be performed in a conventional method. For example, the reacted solution is repeatedly extracted by using an aqueous solution containing the neutralizing agent. After the neutralization treatment or the rinsing treatment are completed, the unreacted phenols and solvents can be removed by a distillation method at a reduced pressure and then concentrated to obtain the compound having a structure of Formula (III-1).

Specific examples of the above-mentioned epihalohydrin are epichlorohydrin, epibromohydrin, or a combination thereof. Before the above-mentioned dehydrohalogenation reaction is performed, alkaline metal hydroxide such as sodium hydroxide, potassium hydroxide and the like can be added prior to or during the dehydrohalogenation reaction. The above-mentioned dehydrohalogenation reaction is performed at 20° C. to 120° C. for 1 hour to 10 hours.

In one embodiment, the above-mentioned alkaline metal hydroxide added to the dehydrohalogenation reaction can be an aqueous solution. In this embodiment, when the aqueous solution of alkaline metal hydroxide is continuously added to a dehydrohalogenation reacting system, the water in the aqueous solution of alkaline metal hydroxide can be removed by continuously distilling.

Before the above-mentioned dehydrohalogenation reaction is performed, quaternary ammonium salts, such as tetramethyl ammonium chloride, tetramethyl ammonium bromide, trimethyl benzyl ammonium chloride, and the like, can be added to a dehydrohalogenation reacting system as a catalyst, and be reacted at 50° C. to 150° C. for 1 hour to 5 hours. Then, alkaline metal hydroxide or an aqueous solution thereof is added to the dehydrohalogenation reacting system, and be reacted at 20° C. to 120° C. for 1 hour to 10 hours, so as to subject to the dehydrohalogenation reaction.

Based on the total equivalent hydroxyl groups in the compound having a structure of Formula (III-1) as 1 equivalent, the amount of the above-mentioned epihalohydrin is 1 equivalent to 20 equivalents, and preferably is 2 equivalents to 10 equivalents. Based on the total equivalent hydroxyl groups having a structure of Formula (III-1) as 1 equivalent, the amount of the above-mentioned alkaline metal hydroxide that was added to the dehydrohalogenation reaction is 0.8 equivalents to 15 equivalents, and preferably is 0.9 equivalents to 11 equivalents.

In addition, for increasing the reactivity of the above-mentioned dehydrohalogenation reaction, the solvent of the dehydrohalogenation reaction can include alcohols such as methanol, ethanol, and the like or polar aprotic solvents such as dimethyl sulfone, dimethyl sulfoxide and the like can also be added to the dehydrohalogenation to react. When the solvent of the dehydrohalogenation reaction is alcohols, based on the epihalohydrin as 100 wt %, the amount of alcohols is 2 wt % to 20 wt %, and preferably is 4 wt % to 15 wt %. When the solvent of the dehydrohalogenation reaction is polar aprotic solvent, based on the epihalohydrin as 100 wt %, the amount of polar aprotic solvent is 5 wt % to 100 wt %, and preferably is 10 wt % to 90 wt %.

After the dehydrohalogenation reaction is complete, a rinse treatment can be optionally performed. Afterwards, the epihalohydrin, the alcohol and the polar aprotic solvent can be removed by reduced pressure distillation, for example, the reduced pressure distillation is performed at 110° C. to 250° C. and in a reduced pressure of less than 1.3 kPa (10 mmHg).

To prevent the resulting epoxy resin from containing hydrolysable halogens, solvents such as toluene, methyl isobutyl ketone or the like, alkali metal hydroxide solutions such as sodium hydroxide, potassium hydroxide or the like can be added to the solution after the dehydrohalogenation reaction is performed, and then the dehydrohalogenation reaction is performed again. In the dehydrohalogenation reaction, based on the total equivalent hydroxyl groups in the compound having a structure of Formula (III-1) as 1 equivalent, the amount of alkali metal hydroxide is 0.01 moles to 0.3 moles, and preferably is 0.05 moles to 0.2 moles. In addition, the above-mentioned dehydrohalogenation reaction is performed at 50° C. to 120° C. for a period of 0.5 hour to 2 hours.

After the dehydrohalogenation reaction is complete, salts can be removed by using filtration, rinse and so on. In addition, solvents such as toluene, methyl isobutyl ketone or the like can be removed by reduced pressure distillation, thereby obtaining an epoxy compound having at least two epoxy groups (i) having a structure of Formula (III). The above-mentioned epoxy compound having at least two epoxy groups (i) having a structure of Formula (III) can include, but not limited to, commercially available products manufactured by NIPPON KAYAKU Co. Ltd., and the trade name is NC-3000, NC-3000H, NC-3000S, NC-3000P and the like.

Compound Having at Least One Carboxyl Group and at Least One Vinyl Unsaturated Group (II)

The aforementioned compound having at least one carboxyl group and at least one vinyl unsaturated group (ii) is selected from the group consisting of the following subgroups (1) to (3): (1) acrylic acid, methacrylic acid, 2-methacryloyloxyethyl butanedioic acid, 2-methacryloyloxybutyl butanedioic acid, 2-methacryloyloxyethyl hexanedioic acid, 2-methacryloyloxybutyl hexanedioic acid, 2-methacryloyloxyethyl hexahydrophthalic acid, 2-methacryloyloxyethyl maleic acid, 2-methacryloyloxypropyl maleic acid, 2-methacryloyloxybutyl maleic acid, 2-methacryloyloxypropyl butanedioic acid, 2-methacryloyloxypropyl hexanedioic acid, 2-methacryloyloxypropyl tetrahydrophthalic acid, 2-methacryloyloxypropyl hydrophthalic acid, 2-methacryloyloxybutyl hydrophthalic acid or 2-methacryloyloxybutyl hydrophthalic acid; (2) a compound synthesized by reacting (methyl)acrylate ester having hydroxyl group(s) with a dicarboxylic acid compound, in which the dicarboxylic acid compound include, but not limited to, hexanedioic acid, butanedioic acid, maleic acid, and phthalic acid; (3) a hemiester compound synthesized by reacting (methyl)acrylate ester having hydroxyl group(s) with a carboxylic acid anhydride compound, in which the carboxylic acid anhydride compound can be the same as the aforementioned carboxylic anhydride compound (iii) (described in more detail later, therefore not repeated here) selectively added to the mixture. The (meth)acrylate ester having hydroxyl group(s) may include, but not limited to, (2-hydroxyethyl)acrylate, (2-hydroxyethyl)methacrylate, (2-hydroxypropyl)acrylate, (2-hydroxypropyl)methacrylate, (4-hydroxybutyl)acrylate, (4-hydroxybutyl)methacrylate, pentaerythritol triacrylate and the like.

The above-mentioned mixture used to form the resin having unsaturated group (F) can selectively include a carboxylic anhydride compound (iii) and/or a compound having an epoxy group (iv). The carboxylic anhydride compound (iii) can be selected from the group consisting of the following subgroups (1) to (2): (1) dicarboxylic acid anhydride compounds such as butanedioic anhydride, maleic anhydride, itaconic anhydride, phthalic anhydride, tetrahydrophthalic anhydride, hexahydrophthalic anhydride, methyltetrahydrophthalic anhydride, methylhexahydrophthalic anhydride, methyl endo-methylene tetrahydrophthalic anhydride, chlorendic anhydride, 1,3-dioxoisobenzofuran-5-carboxylic anhydride and the like; and (2) tetracarboxylic acid anhydride compounds such as benzophenone tetracarboxylic dianhydride (BTDA), diphenyl tetracarboxylic dianhydride, diphenyl ether tetracarboxylic acid dianhydride and the like.

The above-mentioned compound having an epoxy group (iv) is selected from the group consisting of glycidyl methacrylate, 3,4-epoxycyclohexyl methacrylate, glycidyl ether compounds having unsaturated group(s), unsaturated compounds having epoxy group(s) or any combination thereof. The above-mentioned glycidyl ether compounds having unsaturated group(s) include, but not limited to, commercially available products manufactured by Nagase ChemteX Corporation, and the trade name is Denacol EX-111, Denacol EX-121, Denacol EX-141, Denacol EX-145, Denacol EX-146, Denacol EX-171, or Denacol EX-192.

The above-mentioned resin having unsaturated group (F) can be polymerized by the epoxy compound having at least two epoxy groups (i) having a structure of Formula (II) and the compound having at least one carboxyl group and at least one vinyl unsaturated group (ii), so as to obtain an reacting product having hydroxyl group(s). And then, the carboxylic anhydride compound (iii) is added to react. Preferably, based on the total equivalent hydroxyl groups of the reaction product having hydroxyl group(s) as 1 equivalent, the equivalent of the anhydride groups in the carboxylic anhydride compound (iii) is 0.4 equivalent to 1 equivalent, and preferably is 0.75 equivalent to 1 equivalent. When a plurality of the carboxylic anhydride compound (iii) is used in this reaction, they can be added sequentially or simultaneously into the reaction. Preferably, when dicarboxylic acid anhydride compound and tetracarboxylic acid anhydride compound are used as the carboxylic anhydride compound (iii), the molar ratio of the dicarboxylic acid anhydride compound to the tetracarboxylic acid anhydride compound is 1:99 to 90:10, and preferably is 5:95 to 80:20. In addition, the above-mentioned reaction can be performed at 50° C. to 130° C.

The above-mentioned resin having unsaturated group (F) can be obtained by reacting the epoxy compound having at least two epoxy groups (i) having a structure of Formula (III) with the compound having at least one carboxyl group and at least one vinyl unsaturated group (ii), so as to form an reaction product having hydroxyl group(s). And then, the carboxylic anhydride compound (iii) and/or the compound having an epoxy group (iv) is added to subject to a polymerized reaction. Preferably, based on the total equivalent epoxy groups of the epoxy compound having at least two epoxy groups (i) of Formula (III) as 1 equivalent, the acid value of the compound having at least one carboxyl group and at least one vinyl unsaturated group (ii) is from 0.8 equivalent to 1.5 equivalents, and more preferably is 0.9 equivalent to 1.1 equivalents. Based on the total amount of hydroxyl groups in the reaction product having hydroxyl group(s) as 100 mole %, the amount of anhydride compound (iii) is 10 mole % to 100 mole %, preferably is 20 mole % to 100 mole %, and more preferably is 30 mole % to 100 mole %.

When the above-mentioned resin having unsaturated group (F) is prepared, alkaline compounds are usually added to the reacting solution as a reacting catalyst to accelerate the reaction. The above-mentioned reacting catalyst may be used alone or in combinations of two or more, and the reacting catalyst may include, but not limited to, triphenyl phosphine, triphenyl stibine, triethylamine, triethanolamine, tetramethylammonium chloride, benzyltriethylammonium chloride and the like. Preferably, based on the total weight of the epoxy compound having at least two epoxy groups (i) and the compound having at least one carboxyl group and at least one vinyl unsaturated group (ii) as 100 parts by weight, the amount of the reaction catalyst is 0.01 parts by weight to 10 parts by weight, and preferably is 0.3 parts by weight to 5 parts by weight.

In addition, for controlling the degree of polymerization, a polymerization inhibitor is usually added into the reaction solution. The aforementioned polymerization inhibitor may include, but not limited to, methoxyphenol, methylhydroquinone, hydroquinone, 2,6-di-t-butyl-p-cresol, phenothiazine and the like. The above-mentioned polymerization Inhibitor may be used alone or in combinations of two or more. Based on the total weight of the epoxy compound having at least two epoxy groups (i) and the compound having at least one carboxyl group and at least one vinyl unsaturated group (ii) as 100 parts by weight, the amount of the polymerization inhibitor is 0.01 parts by weight to 10 parts by weight, and preferably is 0.1 to 5 parts by weight.

When preparing the resin having unsaturated group (F), a polymerization solvent can be used if necessary. Specific examples of the above-mentioned polymerization solvent may include, but not limited to, alcohol compounds such as ethanol, propanol, isopropanol, butanol, isobutanol, 2-butanol, hexanol, ethylene glycol or the like; ketone compounds such as methyl ethyl ketone, cyclohexanone or the like; aromatic hydrocarbon compounds such as toluene, xylene or the like; cellosolve compounds such as cellosolve, butyl cellosolve or the like; carbitol compounds such as carbitol, butyl carbitol or the like; propylene glycol alkyl ether compounds such as propylene glycol monomethyl ether or the like; poly(propylene glycol) alkyl ether compounds such as di(propylene glycol) methyl ether or the like; acetate ester compounds such as ethyl acetate, butyl acetate, ethylene glycol monoethyl ether acetate, propylene glycol methyl ether acetate or the like; alkyl lactate compounds such as ethyl lactate, butyl lactate or the like; or dialkyl glycol ethers. The aforementioned polymerization solvent may be used alone or in combinations of two or more. Furthermore, the acid value of the resin having unsaturated group (F) is 50 mgKOH/g to 200 mgKOH/g, and preferably is 60 mgKOH/g to 150 mgKOH/g.

Based on the polysiloxane (A) as 100 parts by weight, the amount of the resin having unsaturated group (F) is 10 parts by weight to 200 parts by weight, preferably is 15 parts by weight to 180 parts by weight, and more preferably is 20 parts by weight to 150 parts by weight. Since the resin having unsaturated group (F) has a higher degree of photocurable crosslinking, thus the moisture resistance of the photosensitive resin composition at high temperatures is enhanced. Therefore, when the photosensitive resin composition includes the resin having unsaturated group (F), the reliability of the black matrix can be further improved in high temperature and humidity environment.

### Additive (G)

The additives (G) can be optionally added to the photosensitive resin composition of the present invention as long as the desirable effects of the present invention are not affected. The additives (G) can include, but not limited to, a surfactant, a filler, an adhesion promoting agent, a cross-linking agent, an antioxidant, an anti-coagulant, polymers other than polysiloxane (A) that can enhance various properties (for example, mechanical properties) and the like.

The above-mentioned surfactant is selected from the group consisting of cationic, anionic, nonionic, zwitterionic, polysiloxane, fluorine surfactants and any combination thereof. More specifically, the above-mentioned surfactant can include, but not limited to, polyoxyethylene alkyl ethers such as polyoxyethylene dodecyl ether, polyoxyethylene stearyl ether, polyoxyethylene oleyl ether and the like; polyoxyethylene alkyl phenyl ethers such as polyoxyethylene octyl phenyl ether, polyoxyethylene nonyl phenyl ether and the like; polyethylene glycol diesters such as polyethylene glycol dilaurate, polyethylene glycol distearate and the like; sorbitan fatty acid esters; fatty acid-modified polyesters; and tertiary amine-modified polyurethanes. The above-mentioned surfactant can be used alone or in combinations of two or more.

Specific examples of the above-mentioned surfactants can be commercial product manufactured by Shin-Etsu Chemical Industry Co., Ltd., and the trade name is KP; products manufactured by Toray Dow Corning Silicon Co. Ltd., and the trade name is SF-8427; products manufactured by Kyoei-Sha Yushi Kagaku Kogyo Co., Ltd., and the trade name is Polyflow; products manufactured by Tochem Product Co., Ltd., and the trade name is F-Top; products manufactured by Dainippon Chemicals and Ink Co., Ltd., and the trade name is Megafac; products manufactured by Surnitomo 3M Co., Ltd., and the trade name is Fluorade; products manufactured by Asahi Glass Co., Ltd., and the trade name is Asahi Guard or Serflon; products manufactured by Sino-Japan Chemical Co., Ltd., and the trade name is SINOPOL E8008.

The above-mentioned fluorine surfactants can include, but not limited to, 1,1,2,2-tetrafluorooctyl(1,1,2,2-tetrafluoropropyl)ether, 1,1,2,2-tetrafluorooctylhexyl ether, octaethylene glycol di(1,1,2,2-tetrafluorobutyl) ether, hexaethylene glycol (1,1,2,2,3,3-hexafluoropentyl) ether, octapropylene glycol di(1,1,2,2-tetrafluorobutyl) ether, hexapropylene glycol di(1,1,2,2,3,3-hexafluoropentyl) ether, sodium perfluorododecanesulfonate, 1,1,2,2,8,8,9,9,910,10-decafluorododecane, 1,1,2,2,3,3-hexafluorodecane, sodium fluoroalkylbenzene sulfonate, sodium fluoroalkyl phosphonate, sodium fluoroalkyl carboxylate, fluoroalkyl polyoxyethylene ether, diglycerin tetrakis(fluoroalkylpolyoxyethylene ether), fluoroalkyl ammonium iodido, fluoroalkylbetaine, fluoroalkylpolyoxyethylene ether, perfluoroalkylpolyoxyethylene ether, perfluoroalkylpolyoxy ethanol, or commercially available products manufactured by BM Chemie Co. Ltd., and the trade name is BM-1000 or BM-1100; products manufactured by Dainippon Ink & Chemicals, Inc., and the trade name is Megafac F142D, F172, F173, F183, F178, F191, F471 or F476; products manufactured by Sumitomo 3M Co. Ltd., and the trade name is Fluorad FC 170C, FC-171, FC-430 or FC-431; products manufactured by Asahi Glass Co., Ltd., and the trade name is Surflon S-112, S-113, S-141, S-145, S-382, SC-101, SC-102, SC-103, SC-104, SC-105, or SC-106; products manufactured by Shin Akita Kasei Co., Ltd., and the trade name is F TOP EF301, 303, or 352; products manufactured by NEOSU Co. Ltd., and the trade name is Ftergent FT-100, FT-110, FT-140A, FT-150, FT-250, FT-251, FTX-251, FTX-218, FT-300, FT-310 or FT-400S; products manufactured by DIC Co. Ltd., and the trade name is F-410, F-444, F-445, F-552, F-553 or F-554. The fluorine surfactants can be used alone or in combinations of two or more.

Specific examples of the filler are glass, aluminum and the like.

The adhesion promoting agent can include, but not limited to, melamine compounds, silane-based compounds or the like, which is used to enhance the adhesion between the photosensitive polysiloxane and the substrate with semiconductor materials. The melamine can include, but not limited to, commercial products manufactured by Mitsui Cytec Co. Ltd., and the trade name is Cymel-300 or Cymel-303; products manufactured by Sanwa Chemical Co., Ltd, and the trade name is MW-30MH, MW-30, MS-11, MS-001, MX-750, or MX-706. The silane-based compounds can include, but not limited to, vinyltrimethoxysilane, vinyltriethoxysilane, 3-(methyl) acryloxypropyltrimethoxysilane, vinyl tris(2-methoxyethoxy)silane, N-(2-aminoethyl)-3-aminopropylmethyl dimethoxysilane, N-(2-aminoethyl)-3-aminopropyl trimethoxysilane, 3-aminopropyl triethoxysilane, 3-glycidoxypropyl trimethoxysilane, 3-glycidolypropyl trimethoxysilane, 3-glycidoxypropyl dimethylmethoxysilane, 3-glycidolpropylmethyl diethoxysilane, 2-(3,4-epoxycyclohexyl)ethyl trimethoxysilane, 3-chloropropylmethyl dimethoxysilane, 3-chloropropyl trimethoxysilane, 3-methacryloxypropyl trimethoxysilane, 3-methylpropionyloxopropyl trimethoxysilane, 3-mercaptopropyl trimethoxysilane or the commercial products manufactured by Shin-Etsu Chemical Industry Co. Ltd., and the trade name is KBM-403.

Specific examples of the antioxidant include, but not limited to, 2,2-thio bis(4-methyl-6-t-butylphenol) or 2,6-di-t-butylphenol or the like.

Specific example of the anti-coagulant is sodium polyacrylate or the like.

Specific examples of the cross-linking agent include, but not limited to, epoxy compounds, resins or the like, such as the commercial products manufactured by Japan Epoxy Resins Co. Ltd., and the trade name is 1031S, or 157S-70.

Based on the polysiloxane (A) as 100 parts by weight, the amount of filler, adhesion promoting agent, antioxidant, anti-coagulant, and polymers other than polysiloxane (A) in the additive (G) is less than 10 parts by weight, and preferably is less than 6 parts by weight.

Based on the polysiloxane (A) as 100 parts by weight, the amount of surfactant in the additive (G) is less than 6 parts by weight, and preferably is less than 4 parts by weight.

Based on the polysiloxane (A) as 100 parts by weight, the amount of the cross-linking agent in the additive (G) is less than 100 parts by weight, and preferably is less than 80 parts by weight.

### Preparation of Photosensitive Resin Composition

The photosensitive resin composition of the present invention is generally prepared by: placing the above-mentioned polysiloxane (A), compound having a vinyl unsaturated group (B), photo initiator (C), solvent (D) and black pigment (E) in a agitator and mixed, so that it will uniformly mix to form a solution state; resin having unsaturated group (F) or additives (G) such as surfactant, filler, adhesion promoting agent, cross-linking agent, antioxidant, or anti-coagulant may also be added if necessary. After uniformly mixed, a photosensitive resin composition in a solution state can be obtained.

Based on the polysiloxane (A) as 100 parts by weight, the amount of the compound having a vinyl unsaturated group (B) is 20 parts by weight to 200 parts by weight, the amount of the photo initiator (C) is 10 parts by weight to 100 parts by weight, the amount of solvent (D) is 1000 parts by weight to 5000 parts by weight, and the amount of black pigment (E) is 100 parts by weight to 1000 parts by weight.

Furthermore, based on 100 parts by weight of the amount of the polysiloxane (A), the amount of polysiloxane having an acid anhydride group or epoxy group (A-1) used is 30 parts by weight to 100 parts by weight, and the amount of the compound having an acidic group and at least three vinyl unsaturated groups (B-1) is 10 parts by weight to 150 parts by weight, and the amount of the resin having unsaturated group (F) is 10 parts by weight to 200 parts by weight.

### Preparation of Black Matrix

The black matrix of the present invention is prepared by prebaking, exposuring, developing and postbaking the above-mentioned photosensitive resin composition sequentially. When the film thickness of the black matrix is 1 μm, the optical density is more than 3.0. Preferably, when the film thickness of the black matrix is 1 μm, the optical density is 3.2 to 5.5. And more preferably, when the film thickness of the black matrix is 1 μm, the optical density is 3.5 to 5.5.

The black matrix of the present invention can via spin coating, slit coating, and the like, coat the above-mentioned photosensitive resin composition onto the substrate, and then dried under reduced pressure or prebaked to remove the solvents, thereby forming a prebaked coating film on the substrate. The process conditions for drying under reduced pressure or prebaking depends on the type and the formulating ratio of the above-mentioned components. The drying under reduced pressure is usually at a pressure less than 200 mmHg for 1 second to 20 seconds, and the prebaking is usually performed at 70° C. to 110° C. for 1 minute to 15 minutes. After prebaking, the aforementioned coating film is exposed under a specified photomask. Afterwards, immersing in a developer at 21° C. to 25° C. for 15 seconds to 5 minutes to remove the unwanted parts to form a desired pattern. The light used for the exposure is preferably ultraviolet light such as g-line, h-line, i-line, and the like. The device for providing the ultraviolet light can be a (ultra-)high pressure mercury lamp, or a metal halide lamp.

Specific examples of the developer include, but not limited to, alkali compounds such as sodium hydroxide, potassium hydroxide, sodium carbonate, sodium hydrogen carbonate, potassium carbonate, potassium hydrogen carbonate, sodium silicate, sodium methylsilicate, aqueous ammonia, ethylamine, diethylamine, dimethyl ethanolamine, tetramethylammonium hydroxide, tetraethylammonium hydroxide, choline, pyrrole, piperidine, or 1,8-diazabicyclo-[5,4,0]-7-undecene. The concentration of the developer is 0.001 wt % to 10 wt %, preferably is 0.005 wt % to 5 wt %, and more preferably is 0.01 wt % to 1 wt %.

When these developers are used, water is generally used to wash after development, and then the pattern is air-dried by using compressed air or nitrogen gas. Next, a hot plate, an oven or other heating device is used to postbake. The postbake is generally carried out at 150° C. to 250° C. for 5 minutes to 60 minutes on the hot plate, or for 15 minutes to 150 minutes in the oven. After the above steps, the black matrix can be formed on the substrate.

Specific examples of the above-mentioned substrates are alkali-free glass, soda-lime glass, hard glass (Pyrex glass), quartz glass, similar glasses coated with a transparent conductive film thereon and the like, commonly used in a liquid crystal display; or a photoelectric conversion substrate (for example, a silicon substrate) used in a solid-state image sensor.

### Preparation of Pixel Layer and Color Filter

The color filter of the present invention can be formed by coating (via various coating methods such as spin coating, cast coating or roll coating) the mixed solution-state photosensitive resin composition for a color filter onto a substrate, in which the black matrix for separating each pixel colored layer has been formed on the aforementioned substrate, and the black matrix is formed by the aforementioned photosensitive resin composition. After the mixed solution-state photosensitive resin composition is coated, most solvents are removed by drying under reduced pressure. Next, the remaining solvents are removed by prebaking, so as to form a prebaked coating film. The parameters for drying under reduced pressure or prebaking depends on the type and the formulating ratio of the components. Typically, the drying under reduced pressure is performed at 0 mmHg to 200 mmHg for 1 second to 60 seconds, and the prebake is carried out at 70° C. to 110° C. for 1 minute to 15 minutes. After the prebake, the prebaked coating film is exposed under a specified mask to develop. Next, the prebaked coating film is immersed in the above-mentioned developer at 21° C. to 25° C. for 15 seconds to 5 minutes, so as to remove the unwanted parts to form a desired pattern. The light used for the exposure is preferably ultraviolet light such as g-line, h-line, i-line, and the like, the device for providing the ultraviolet light can be a (ultra)high pressure mercury lamp, or a metal halide lamp.

After development, wash with water, and then air-dry the pattern by using compressed air or nitrogen gas, followed by using a hot plate, an oven or other heating devices to postbake. The postbake can be carried out in the above-mentioned conditions, therefore not reciting them in detail here again.

By repeating the above-mentioned steps for each color (mainly including red, green and blue), the pixel layer of the color filter can be made. Moreover, an indium-tin oxide (ITO) film can be formed on the pixel layer at 220° C. to 250° C. in a vacuum environment, if necessary, after the ITO film is etched and wired, a polyimide for a LC alignment film can be coated and burnt on the ITO film, so as to obtain the color filter for a LCD device.

### Preparation of Liquid Crystal Display Devices

The LCD device of the present invention includes the above-mentioned color filter substrate formed by the aforementioned method and a TFT driving substrate. Next, the two aforementioned substrates are arranged to oppose each other with a space (cell gap) in between, the peripheral portions of the two substrates were joined together with a sealing agent, liquid crystals were filled into the cell gap defined by the surfaces of the substrates and the sealing agent. Afterwards, an injection hole was sealed up to form a liquid crystal cell. Then, a polarizer was affixed to the outer surface of the liquid crystal cell, i.e. the other side of the liquid crystal cell, to obtain the liquid crystal display device.

The aforementioned liquid crystal, i.e. the liquid crystal compound or liquid crystal composition, is not particularly limited here, and it can be any liquid crystal compound or composition.

Furthermore, the above-mentioned liquid crystal alignment film, which is used for restricting the orientation of the liquid crystal molecules, is not particularly limited here, and it can be any inorganic or organic substance. Methods for forming the liquid crystal alignment film can be carried out by anyone skilled in this art and is also not the main focus of the invention, thus not described in detail here.

Various applications of the present invention will be described in more details referring to several exemplary embodiments below, and are not intended to be limiting. Thus, one skilled in the art can easily ascertain the essential characteristics of the present invention and, without departing from the spirit and scope thereof, can make various changes and modifications of the invention to adapt it to various usages and conditions.

### DETAILED DESCRIPTION

### Preparation of Polysiloxane (A)

The following polysiloxane (A) of Preparation Example A-1-1 to A-2-2 is prepared according to Table 1.

### Preparation Example A-1-1

0.30 moles of methyltrimethoxysilane (referred hereinafter as MTMS), 0.45 moles of phenyltrimethoxysilane (referred hereinafter as PTMS), 0.05 moles of 3-(triethoxysilyl)propyl succinic anhydride (referred hereinafter as GF-20), 0.2 moles of 3-(trimethoxysilyl)propylmethyl acrylate (referred hereinafter as KBM-503), and 180 grams of 4-hydroxy-4-methyl-2-pentanone (referred hereinafter as DAA) was added into a 500 ml three-necked flask, and stirred at room temperature while adding an oxalic acid aqueous solution (0.40 g oxalic acid/75 g H2O) over a 30 minutes duration. Next, the flask was immersed in a 30° C. oil bath, after stirring for 30 minutes, the aforementioned reaction mixture was heated to 110° C. and stirred continuously to carry out the polycondensation reaction. After reacting for 6 hours, the solvents in the mixture were removed by distillation to obtain polysiloxane (A-1-1).

### Preparation Example A-1-2 to A-2-2

The preparation method in Preparation Example A-1-2 to A-2-2 uses the same method as in Preparation Example A-1-1 to prepare the polysiloxane (A), the difference is that in Preparation Example A-1-2 to A-2-2, the type and amount of the raw material used for the polysiloxane and polymerization conditions were changed, the formulation and polymerization conditions are shown in Table 1, thus not repeated here again.

### Preparation of Resin Having Unsaturated Group (F)

### Synthesis Example F-1

100 parts by weight of fluorene epoxy compound (ESF-300, manufactured by Nippon Steel Chemical Co., epoxy equivalent: 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol monomethyl ether acetate was added into a 500 ml four-necked flask in a continuous manner, and controlled at a feeding rate of 25 parts by weight/min. The reaction was conducted at a temperature ranging from 100° C. to 110° C., after a period of 15 hours, a light yellowish transparent mixture with a solid concentration of 50 wt % can be obtained.

Next, 100 parts by weight of the above light yellowish transparent mixture was dissolved in 25 parts by weight of ethylene glycol monoethyl ether acetate while adding 6 parts by weight of tetrahydrophthalic anhydride and 13 parts by weight of benzophenone tetracarboxylic dianhydride. The reaction was conducted by heating at a temperature from 110° C. to 115° C. for a period of 2 hours, a resin having unsaturated group (F−1) with an acid value of 98.0 mgKOH/g can be obtained.

### Synthesis Example F-2

400 parts by weight of epoxy compound (NC-3000, manufactured by Nippon Kayaku Co. Ltd., epoxy equivalent: 288), 102 parts by weight of acrylic acid, 0.3 part by weight of methoxyphenol, 5 parts by weight of triphenyl phosphine, and 264 parts by weight of propylene glycol monomethyl ether acetate were reacted in a reaction flask. Heated and maintained at a temperature of 95° C. for a period of 9 hours to obtain an intermediate product with an acid value of 2.2 mgKOH/g. Next, 151 parts by weight of tetrahydrophthalic anhydride was added and reacted at a temperature of 95° C. for a period of 4 hours to obtain a resin having unsaturated group (F-2), which has an acid value of 102 mgKOH/g and an average molecular weight of 3,200.

### Preparation of Photosensitive Resin Composition

The following photosensitive resin composition of Examples 1 to 8 and Comparative Examples 1 to 3 is prepared according to Table 2 and Table 3.

### Example 1

100 parts by weight of the above polysiloxane of Preparation Example A-1-1, 10 parts by weight of the esterified product of pentaerythritol triacrylate and phthalic acid (hereinafter referred to as B-1-1), 10 parts by weight of dipentaerythritol hexaacrylate (manufactured by Toagosei; hereinafter referred to as B-2-1), 10 parts by weight of 1-[4-(phenylthio)phenyl]-octane-1-2-dione-(O-benzoyloxime) (trade name OXE01, manufactured by Ciba Specialty Chemicals Co.; hereinafter referred to as C-1), 100 parts by weight of pigments (trade name MA100, manufactured by Mitsubishi Chemical Co.; hereinafter referred to as E-1), and 1000 parts by weight of propylene glycol methyl ether acetate (hereinafter referred to as D-1) were added, dissolved and mixed in a shaking agitator and a photosensitive resin composition of Example 1 can be obtained, the photosensitive resin composition product were evaluated by the evaluation methods described below and the results are shown in Table 2, wherein the testing methods for reliability under high temperature and high humidity are described later.

### Examples 2 to 8 and Comparative Examples 1 to 3

Examples 2 to 8 and Comparative Examples 1 to 3 uses the same method as Example 1 to prepare the photosensitive resin composition, the difference is that in Examples 2 to 8 and Comparative Examples 1 to 3, the type and amount of the raw material used for the photosensitive resin composition and polymerization conditions were changed, the formulation and evaluation results are shown in Table 2 and Table 3, thus not repeated here again.

### Evaluation Methods

### 1. Reliability Under High Temperature and High Humidity

The photosensitive resin composition obtained in the above examples was spin-coated onto a glass substrate of 100 mm×100 mm by using a coater (MS-A150, purchased from MIKASA, Co. Ltd., Tokyo, Japan). Followed by drying under a reduced pressure of 100 mmHg for 5 seconds. Next, prebaking the aforementioned glass substrate in an oven at 100° C. for 2 minutes to form a prebaked film with a thickness of 1.2 μm.

The aforesaid prebaked film was irradiated with ultra-violet light by using an exposure machine (Model No. AG500-4N, manufactured by M&R Nano Technology Co. Ltd., and the exposing energy is 100 mJ/cm²). After the ultra-violet irradiation the prebaked film was immersed in a developer (0.4% potassium hydroxide solution) at 23° C. for 2 minutes, followed by washing with pure water and then baking the prebaked film at 230° C. for 60 minutes to obtain a light-shielding film on the glass substrate with a thickness of 1.0 μm.

Next, the aforementioned light-shielding film was placed in a oven at 121° C., 2 atm and 100% relative humidity for 8 hours, the reliability of the light-shielding film under high temperature and high humidity is tested according to the adhesiveness testing method disclosed in JIS.5400(1900)8.5. First, the above-mentioned light-shielding films were cut with a cutter knife to form 100 grid patterns. Next, the grid patterns were adhered by a tape, and then the tape was removed. An evaluation was made according to the residual grid patterns and the following criterion.

⊚: 5B.

◯: 4B.

Δ: 2B to 3B.

X: 0B to 1B.

Wherein, 5B: the grid patterns do not fall.
4B: 0%<the amount of the fallen grid patterns≦5%.
3B: 5%<the amount of the fallen grid patterns≦15%.
2B: 15%<the amount of the fallen grid patterns≦35%.
1B: 35%<the amount of the fallen grid patterns≦65%.
0B: 65%<the amount of the fallen grid patterns≦100%.

From the results of Table 2 and Table 3, when the compound having a vinyl unsaturated group (B) of the photosensitive resin composition contains the compound having an acidic group and at least three vinyl unsaturated groups (B-1), the product black matrix has good reliability under high temperature and high humidity.

Moreover, when the polysiloxane (A) of the photosensitive resin composition contains the polysiloxane having an acid anhydride group or epoxy group (A-1) and the compound having a vinyl unsaturated group (B) contains the above-mentioned compound (B-1) at the same time, the reliability of the product black matrix under high temperature and high humidity can be further enhanced.

In addition, when the photosensitive resin composition includes the above-mentioned compound (B-1) and the resin having unsaturated group (F), the product black matrix has better reliability under high temperature and high humidity.

Furthermore, it is worth mentioning that specific compounds, specific compositions, specific reaction conditions, specific processes, specific evaluation methods or specific instruments are employed as exemplary embodiments in the present invention for illustrating the photosensitive resin composition, the color filter and liquid crystal display device in the present invention, as is understood by a person skilled in the art, the invention is not limited thereto, without departing from the spirit and scope of the present invention, the photosensitive resin composition, the color filter and liquid crystal display device in the present invention can include other compounds, other compositions, other reaction conditions, other processes, other evaluation methods or other instruments rather than limited to the aforementioned examples.

Although the present invention has been described in considerable detail with reference to certain embodiments thereof, other embodiments are possible. It will be apparent to those skilled in the art that various modifications and variations can be made to the structure of the present invention without departing from the scope or spirit of the invention. Therefore, the spirit and scope of the appended claims should not be limited to the description of the embodiments contained herein.

TABLE 1

| | | | | | | | | | | | | | | | Pply- |
|---|---|---|---|---|---|---|---|---|---|---|---|---|---|---|---|
| | | | | | | | | | | | | | | | con- |
| Prep- | | | | | | | | | | | | | | | den- |
| ara- | COMPOSITION | | | | | | | | | | | | | Reac- | sa- |
| tion | Silane Monomer/Polysiloxane (mol) | | | | | | | | | | | Catalyst (g) | | tion | tion |
| Exam- | | | | | GF- | | | DMS- | KBM- | Solvent (g) | | | Oxalic | Temp. | Time |
| ple | MTMS | DMDMS | PTMS | PTES | 20 | TMSG | TMSOX | S27 | 503 | PGEE | DAA | Water | Acid | (° C.) | (hrs) |
| A-1-1 | 0.3 | | 0.45 | | 0.05 | | | | 0.2 | | 180 | 75 | 0.4 | 110 | 6 |
| A-1-2 | | 0.45 | | 0.5 | | 0.04 | | 0.01 | | 100 | 100 | 75 | 0.35 | 105 | 6 |
| A-1-3 | 0.4 | | 0.3 | 0.25 | | | 0.05 | | | 160 | | 75 | 0.5 | 120 | 6 |
| A-2-1 | 0.4 | | 0.6 | | | | | | | | 200 | 75 | 0.4 | 110 | 6 |
| A-2-2 | 0.3 | | 0.5 | 0.02 | | | | | | 200 | | 75 | 0.4 | 110 | 6 |

| | |
|---|---|
| Abbreviation | Compound Name |
| MTMS | methyltrimethoxysilane |
| DMDMS | dimethyldimethoxysilane |
| PTMS | phenyltrimethoxysilane |
| PTES | phenyltriethoxysilane |
| GF-20 | 3-(triethoxysilyl)propyl succinic anhydride |
| TMSG | 3-(trimethoxysilyl)propyl glutaric anhydride |
| TMSOX | 3-ethyl-3-{[3-(trimethoxysilyl)propoxy]methyl}oxetane |
| DMS-S27 | silanol terminated polysiloxane (Manufactured by Gelest) |
| KBM-503 | 3-methacryloxypropyl trimethoxysilane |
| PGEE | propylene glycol monoethyl ether |
| DAA | 4-hydroxy-4-methyl-2-pentanone |

TABLE 2

| | | | Example | | | | | | | |
|---|---|---|---|---|---|---|---|---|---|---|
| Component | | | 1 | 2 | 3 | 4 | 5 | 6 | 7 | 8 |
| Polysiloxane (A) | A-1 | A-1-1 | 100 | | | | | 30 | | |
| (parts by weight) | | A-1-2 | | 100 | 50 | | | | 50 | |
| | | A-1-3 | | | 50 | | | | | 70 |
| | A-2 | A-2-1 | | | | 100 | | 70 | | 30 |
| | | A-2-2 | | | | | 100 | | 50 | |
| Compound Having a | B-1 | B-1-1 | 10 | | | 80 | | | 50 | 50 |
| Vinyl Unsaturated | | B-1-2 | | 30 | | | 120 | | 50 | |
| Group (B) | | B-1-3 | | | 50 | | | 150 | | |
| (parts by weight) | B-2 | B-2-1 | 10 | | | | | | 100 | |
| | | B-2-2 | | | 20 | | | | | |

| | | | | | | | | | |
|---|---|---|---|---|---|---|---|---|---|
| Photo Initiator (C) | C-1 | 10 | | | 50 | | | 50 | 50 |
| (parts by weight) | C-2 | | 20 | 25 | | 60 | | | |
| | C-3 | | | 5 | | | 80 | 50 | |
| Solvent (D) | D-1 | 1000 | | 2000 | 3000 | | 4000 | 2000 | 3000 |
| (parts by weight) | D-2 | | 1500 | 500 | | 3500 | | 3000 | |
| Black Pigment (E) | E-1 | 100 | | 350 | 200 | | 700 | | 500 |
| (parts by weight) | E-2 | | 250 | | 250 | 600 | | 1000 | |
| Resin Having | F-1 | | | | 10 | | | | |
| Unsaturated Group (F) | F-2 | | | | | | | 50 | 100 |
| (parts by weight) | | | | | | | | | |
| Additives (G) | G-1 | | 2 | | | | | | |
| (parts by weight) | G-2 | | | | | | 1 | | |
| Evaluation Results | Reliability Under | ⊚ | ⊚ | ⊚ | ⊚ | ◯ | ⊚ | ⊚ | ⊚ |
| | High Temp. and | | | | | | | | |
| | Humidity | | | | | | | | |

| | | |
|---|---|---|
| Abbr. | Compound Name/Product Name | |
| B-1-1 | ester compounds of pentaerythritol triacrylate and | |
| | phthalic acid | |
| B-1-2 | ester compounds of dipentaerythritol pentaacrylate | |
| | and succinic acid | |
| B-1-3 | TO-1382 | Manufactured by Toagosei |
| B-2-1 | dipentaerythritol hexaacrylate | Manufactured by Toagosei |
| B-2-2 | dipentaerythritol tetraacrylate | Manufactured by Toagosei |
| C-1 | 1-[4-(phenylthio)phenyl]-octane-1-2-dione- | Manufactured by Ciba Specialty |
| | (O-benzoyloxime)/OXE01 | Chemicals |
| C-2 | 1-[9-ethyl-6-(2-methylbenzoyl)-9H-carbazol-3-yl]- | Manufactured by Ciba Specialty |
| | ethylketo-1-(O-acetyloxime)/OXE02 | Chemicals |
| C-3 | 2-methyl-1-[4-(methylthio) phenyl]-2-morpholino-1- | Manufactured by Ciba Specialty |
| | propanone/IRGACURE 907 | Chemicals |
| D-1 | propylene glycol monomethyl ether acetate | |
| D-2 | cyclohexanone | |
| E-1 | MA100 | Manufactured by Mitsubishi Chemical |
| E-2 | MA230 | Manufactured by Mitsubishi Chemical |
| F-1 | Synthesis example F-1 | |
| F-2 | Synthesis example F-2 | |
| G-1 | KBM-403 | Manufactured by Shin Etsu Chemical |
| G-2 | F-554 | Manufactured by DIC |

TABLE 3

| | | | Comparative | | |
|---|---|---|---|---|---|
| | | | Example | | |
| Component | | | 1 | 2 | 3 |
| Polysiloxane (A) (parts | A-1 | A-1-1 | 100 | | |
| by weight) | | A-1-2 | | 100 | 50 |
| | | A-1-3 | | | 50 |
| | A-2 | A-2-1 | | | |
| | | A-2-2 | | | |
| Compound Having a | B-1 | B-1-1 | 10 | | |
| Vinyl Unsaturated | | B-1-2 | | 30 | |
| Group (B) (parts by | | B-1-3 | | | 50 |
| weight) | B-2 | B-2-1 | 10 | | |
| | | B-2-2 | | | 20 |

| | | | | |
|---|---|---|---|---|
| Photo Initiator (C) (parts | C-1 | 10 | | |
| by weight) | C-2 | | 20 | 25 |
| | C-3 | | | 5 |
| Solvent (D) (parts by | D-1 | 1000 | | 2000 |
| weight) | D-2 | | 1500 | 500 |
| Black Pigment (E) (parts | E-1 | 100 | | 350 |
| by weight) | E-2 | | 250 | |
| Resin Having | F-1 | | | |
| Unsaturated Group (F) | F-2 | | | |
| (parts by weight) | | | | |
| Additives (G) (parts by | G-1 | | 2 | |
| weight) | G-2 | | | |
| Evaluation Results | Reliability Under | X | X | X |
| | High Temp. | | | |
| | and Humidity | | | |

| | | |
|---|---|---|
| Abbr. | Compound Name/Product Name | |
| B-1-1 | ester compounds of pentaerythritol triacrylate and phthalic acid | |
| B-1-2 | ester compounds of dipentaerythritol pentaacrylate and succinic acid | |
| B-1-3 | TO-1382 | Manufactured by Toagosei |
| B-2-1 | dipentaerythritol hexaacrylate | Manufactured by Toagosei |
| B-2-2 | dipentaerythritol tetraacrylate | Manufactured by Toagosei |
| C-1 | 1-[4-(phenylthio)phenyl]-octane-1-2-dione-(O-benzoyloxime)/OXE01 | Manufactured by Ciba Specialty Chemicals |
| C-2 | 1-[9-ethyl-6-(2-methylbenzoyl)-9H-carbazol-3-yl]-ethylketo-1-(O-acetyloxime)/ | Manufactured by Ciba Specialty Chemicals |
| | OXE 02 | |
| C-3 | 2-methyl-1-[4-(methylthio) phenyl]-2-morpholino-1-propanone/IRGACURE 907 | Manufactured by Ciba Specialty Chemicals |
| D-1 | propylene glycol monomethyl ether acetate | |
| D-2 | cyclohexanone | |
| E-1 | MA100 | Manufactured by Mitsubishi Chemical |
| E-2 | MA230 | Manufactured by Mitsubishi Chemical |
| F-1 | Synthesis example F-1 | |
| F-2 | Synthesis example F-2 | |
| G-1 | KBM-403 | Manufactured by Shin□Etsu Chemical |
| G-2 | F-554 | Manufactured by DIC |

What is claimed is:

1. A photosensitive resin composition, comprising:
polysiloxane (A);
a compound having a vinyl unsaturated group (B);
a photo initiator (C);
a solvent (D); and
a black pigment (E),
wherein the compound having a vinyl unsaturated group (B) comprises a compound having an acidic group and at least three vinyl unsaturated groups (B-1).

2. The photosensitive resin composition according to claim 1, wherein the polysiloxane (A) comprises a polysiloxane having an acid anhydride group or epoxy group (A-1), the polysiloxane having an acid anhydride group or epoxy group (A-1) is obtained by subjecting a reactant to hydrolysis and partial condensation, and the reactant includes at least one silane monomer having a structure of Formula (I):
Si(R₁)ₐ(OR₂)₄₋ₐ (I)
wherein, in the Formula (I), a represents an integer of 1 to 3; when a represents 2 or 3, a plurality of R₁ are independently the same or different, wherein at least one of R₁ represent a C₁-C₁₀ alkyl group substituted by an acid anhydride group, a C₁-C₁₀ alkyl group substituted by an epoxy group or an alkoxy group substituted by an epoxy group; the remaining R₁ represent a hydrogen atom, a C₁-C₁₀ alkyl group, a C₂-C₁₀ alkenyl group or a C₆-C₁₅ aryl group; R₂ represents a hydrogen atom, a C₁-C₆ alkyl group, a C₁-C₆ acyl group or a C₆-C₁₅ aryl group; and when (4-a) represents 2 or 3, R₂ are independently the same or different.

3. The photosensitive resin composition according to claim 1, further comprising:
a resin having unsaturated group (F), prepared by polymerization of a mixture, wherein the mixture comprises an epoxy compound having at least two epoxy groups (i) and a compound having at least one carboxyl group and at least one vinyl unsaturated group (ii).

4. The photosensitive resin composition according to claim 3, wherein the epoxy compound having at least two epoxy groups (i) has a structure of Formula (II) or Formula (III): 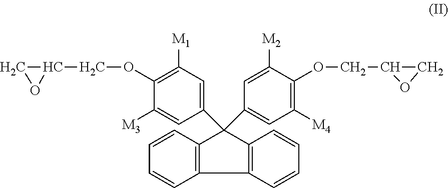
wherein, in the Formula (II), M₁, M₂, M₃ and M₄ are independently the same or different, and M₁, M₂, M₃ and M₄ independently represent a hydrogen atom, a halogen atom, a C₁-C₅ alkyl group, a C₁-C₅ alkoxy group, a C₆-C₁₂ aryl group or a C₆-C₁₂ aralkyl group; 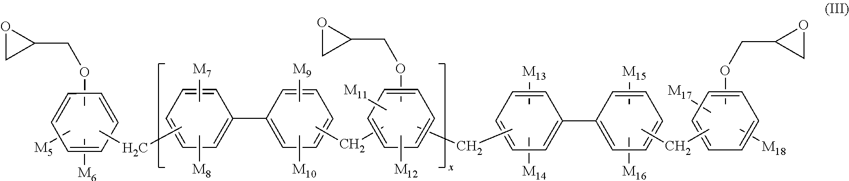
wherein, in the Formula (III), M₅ to M₁₆ are independently the same or different, and M₅ to M₁₈ represent a hydrogen atom, a halogen atom, a C₁-C₈ alkyl group, a C₆-C₁₅ aryl group, and x represents an integer of 0 to 10.

5. The photosensitive resin composition according to claim 1, based on the polysiloxane (A) as 100 parts by weight, the amount of the compound having a vinyl unsaturated group (B) is 20 parts by weight to 200 parts by weight, the amount of the photo initiator (C) is 10 parts by weight to 100 parts by weight, the amount of the solvent (D) is 1000 parts by weight to 5000 parts by weight and the amount of the black pigment (E) is 100 parts by weight to 1000 parts by weight.

6. The photosensitive resin composition according to claim 1, based on the polysiloxane (A) as 100 parts by weight, the amount of the compound having an acidic group and at least three vinyl unsaturated groups (B-1) is 10 parts by weight to 150 parts by weight.

7. The photosensitive resin composition according to claim 2, based on the polysiloxane (A) as 100 parts by weight, the amount of the polysiloxane having an acid anhydride group or epoxy group (A-1) is 30 parts by weight to 100 parts by weight.

8. The photosensitive resin composition according to claim 3, wherein based on 100 parts by weight of the amount of said polysiloxane (A) used, the amount of said resin having unsaturated group (F) used is 10 parts by weight to 200 parts by weight.

9. A black matrix formed by a photosensitive resin composition, wherein the photosensitive resin composition comprises:
polysiloxane (A);
a compound having a vinyl unsaturated group (B);
a photo initiator (C);
a solvent (D); and
a black pigment (E),
wherein the compound having a vinyl unsaturated group (B) comprises a compound having an acidic group and at least three vinyl unsaturated groups (B-1).

10. The black matrix according to claim 9, wherein the polysiloxane (A) comprises a polysiloxane having an acid anhydride group or epoxy group (A-1), the polysiloxane having an acid anhydride group or epoxy group (A-1) is obtained by subjecting a reactant to hydrolysis and partial condensation, and the reactant includes at least one silane monomer having a structure of Formula (I):
Si(R₁)ₐ(OR₂)₄₋ₐ (I)
wherein, in the Formula (I), a represents an integer of 1 to 3; when a represents 2 or 3, a plurality of R₁ are independently the same or different, wherein at least one of R₁ represent a C₁-C₁₀ alkyl group substituted by an acid anhydride group, a C₁-C₁₀ alkyl group substituted by an epoxy group or an alkoxy group substituted by an epoxy group; the remaining R₁ represent a hydrogen atom, a C₁-C₁₀ alkyl group, a C₂-C₁₀ alkenyl group or a C₆-C₁₅ aryl group; R₂ represents a hydrogen atom, a C₁-C₆ alkyl group, a C₁-C₆ acyl group or a C₆-C₁₅ aryl group; and when (4-a) represents 2 or 3, R₂ are independently the same or different.

11. The black matrix according to claim 9, further comprising:
a resin having unsaturated group (F), prepared by polymerization of a mixture, wherein the mixture comprises an epoxy compound having at least two epoxy groups (i) and a compound having at least one carboxyl group and at least one vinyl unsaturated group (ii).

12. The black matrix according to claim 11, wherein the epoxy compound having at least two epoxy groups (i) has a structure of Formula (II) or Formula (III): 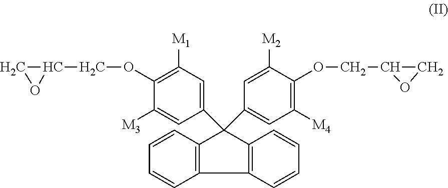
wherein, in the Formula (II), M₁, M₂, M₃ and M₄ are independently the same or different, and M₁, M₂, M₃ and M₄ independently represent a hydrogen atom, a halogen atom, a C₁-C₅ alkyl group, a C₁-C₅ alkoxy group, a C₆-C₁₂ aryl group or a C₆-C₁₂ aralkyl group; 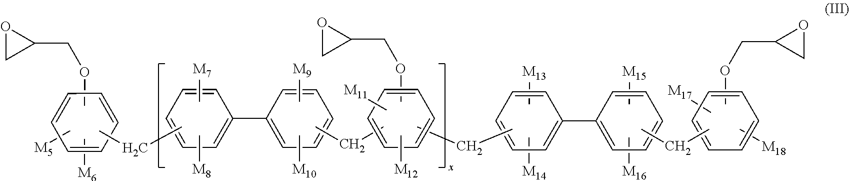
wherein, in the Formula (III), M₅ to M₁₈ are independently the same or different, and M₅ to M₁₈ represent a hydrogen atom, a halogen atom, a C₁-C₈ alkyl group, a C₆-C₁₅ aryl group, and x represents an integer of 0 to 10.

13. The black matrix according to claim 9, based on the polysiloxane (A) as 100 parts by weight, the amount of the compound having a vinyl unsaturated group (B) is 20 parts by weight to 200 parts by weight, the amount of the photo initiator (C) is 10 parts by weight to 100 parts by weight, the amount of the solvent (D) is 1000 parts by weight to 5000 parts by weight and the amount of the black pigment (E) is 100 parts by weight to 1000 parts by weight.

14. The black matrix according to claim 9, based on the polysiloxane (A) as 100 parts by weight, the amount of the compound having an acidic group and at least three vinyl unsaturated groups (B-1) is 10 parts by weight to 150 parts by weight.

15. The black matrix according to claim 10, based on the polysiloxane (A) as 100 parts by weight, the amount of the polysiloxane having an acid anhydride group or epoxy group (A-1) is 30 parts by weight to 100 parts by weight.

16. The black matrix according to claim 11, wherein based on 100 parts by weight of the amount of said polysiloxane (A) used, the amount of said resin having unsaturated group (F) used is 10 parts by weight to 200 parts by weight.

17. A color filter comprising a black matrix according to claim 9.

18. A liquid crystal display device comprising a color filter according to claim 17.
